(19) United States
(12) Patent Application Publication
(10) Pub. No.: US 2026/0079462 A1
(43) Pub. Date: Mar. 19, 2026

(54) METHOD OF MANAGING MANUFACTURING LINE

(71) Applicant: Kioxia Corporation, Tokyo (JP)

(72) Inventor: Teruhiko TENNOJI, Yokkaichi (JP)

(73) Assignee: Kioxia Corporation, Tokyo (JP)

(21) Appl. No.: 19/070,783

(22) Filed: Mar. 5, 2025

(30) Foreign Application Priority Data
Sep. 19, 2024 (JP) 2024-162660

(51) Int. Cl. G05B 19/042

(52) U.S. Cl. CPC G05B 19/042; G05B 2219/25421

(57) ABSTRACT

According to one embodiment, a method of managing a manufacturing line is provided. The method of managing a manufacturing line includes determining a variation characteristic of a load factor of the manufacturing line that includes multiple resources. The method of managing a manufacturing line includes determining a variation characteristic of a load factor of each of the multiple resources. The method of managing a manufacturing line includes identifying the resource that is to be improved out of the multiple resources in response to the variation characteristic of the load factor of the manufacturing line and the variation characteristic of the load factor of each of the resources.

### CROSS-REFERENCE TO RELATED APPLICATIONS

This application is based upon and claims the benefit of Japanese Patent Application No. 2024-162660, filed on Sep. 19, 2024; the entire contents of which are incorporated herein by reference.

### FIELD

Embodiments described herein relate generally to a method of managing a manufacturing line.

### BACKGROUND

When a lot is input in a process area including multiple resources in a manufacturing line, the resources operate to process the lot. In the manufacturing line, it is desirable to efficiently process the lot.

### BRIEF DESCRIPTION OF THE DRAWINGS

FIG. 1 is a diagram illustrating a configuration of a manufacturing line according to a first embodiment;

FIGS. 2A to 2C are diagrams illustrating fluctuations in lot inflow, resource capacity, and resource stock quantity according to the first embodiment;

FIG. 3 is a diagram illustrating an unsteady change in norm according to the first embodiment;

FIG. 4 is a diagram illustrating a functional configuration of a management system according to the first embodiment;

FIGS. 5A to 5D are diagrams illustrating an outline of a procedure for determining a resource that is to be improved according to the first embodiment;

FIG. 6 is a diagram illustrating a hardware configuration of the management system according to the first embodiment;

FIG. 7 is a flowchart illustrating an outline of an operation conducted by the management system according to the first embodiment;

FIG. 8 is a flowchart illustrating a process for determining a variation characteristic of a load factor of a manufacturing line according to the first embodiment;

FIG. 9 is a flowchart illustrating a process for determining a variation characteristic of a load factor of a resource according to the first embodiment;

FIG. 10 is a flowchart illustrating a process for identifying a resource that is to be improved according to the first embodiment;

FIG. 11 is a diagram illustrating an outline of coordination between a Q priority and a U priority (critical ratio) according to a second embodiment:

FIG. 12 is a diagram illustrating a functional configuration of a management system according to the second embodiment;

FIG. 13 is a flowchart illustrating an outline of coordination between a Q priority and a U priority according to the second embodiment;

FIG. 14 is a flowchart illustrating priority determination according to the second embodiment;

FIG. 15 is a flowchart illustrating a process for determining a lot that is to be preferentially processed by a resource according to the second embodiment;

FIG. 16 is a diagram illustrating resources of a batch-fed type according to a third embodiment;

FIG. 17 is a diagram illustrating a functional configuration of a management system according to the third embodiment;

FIG. 18 is a diagram illustrating an example of a number of lots to be input to a resource of the batch-fed type according to the third embodiment;

FIG. 19 is a flowchart illustrating a process relating to resources of the batch-fed type according to the third embodiment;

FIG. 20 is a flowchart illustrating a process for determining a lot waiting time according to the third embodiment; and

FIG. 21 is a flowchart illustrating a process for shortening a lengthy lot stay according to the third embodiment.

### DETAILED DESCRIPTION

In general, according to one embodiment, there is provided a method of managing a manufacturing line. The method of managing a manufacturing line includes determining a variation characteristic of a load factor of the manufacturing line that includes multiple resources;
determining a variation characteristic of a load factor of each of the multiple resources. The method of managing a manufacturing line includes identifying the resource that is to be improved out of the multiple resources in response to the variation characteristic of the load factor of the manufacturing line and the variation characteristic of the load factor of the resource.

Exemplary embodiments of a method of managing a manufacturing line will be explained below in detail with reference to the accompanying drawings. The present invention is not limited to the following embodiments.

### First Embodiment

A method of managing a manufacturing line according to a first embodiment is designed to manage a manufacturing line in which multiple process areas are situated. The process areas each include multiple resources. When a job is input in any of the process areas in the manufacturing line, the resources operate to process the job. The method of managing a manufacturing line has a device in order for the job to be efficiently processed on the manufacturing line. The job described herein refers to an object to be processed by the resources.

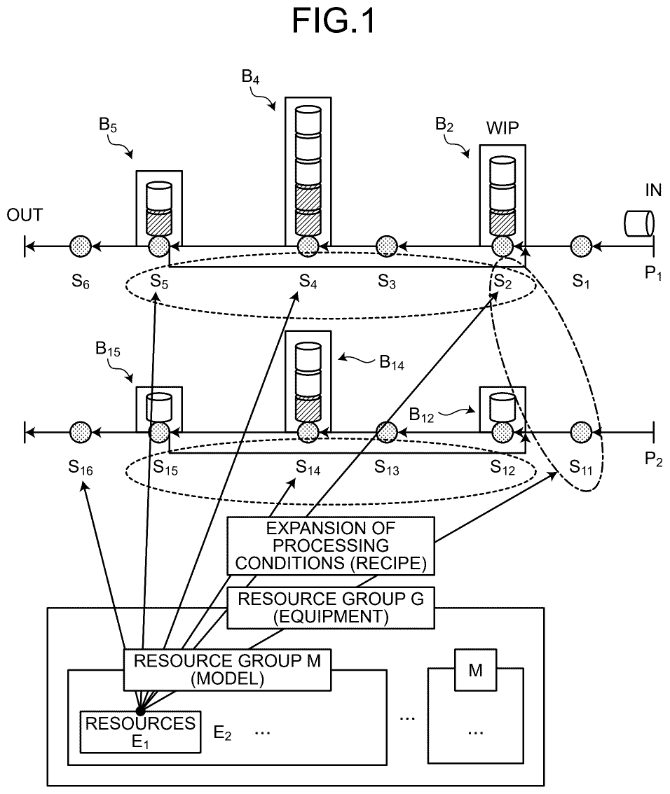

FIG. 1 is a diagram illustrating a configuration of a manufacturing line according to the first embodiment. In a manufacturing plant for manufacturing an object to be manufactured, multiple manufacturing lines P₁ and P₂ are located. Although two manufacturing lines P₁ and P₂ are exemplified in FIG. 1, three or more manufacturing lines may be situated in the manufacturing plant.

As illustrated in FIG. 1, multiple process areas S₁, S₂, . . . . S₆ are situated in the manufacturing line P₁. The multiple process areas S₁, S₂, . . . S₆ correspond to multiple processes in a method of manufacturing an object to be manufactured. Similarly, multiple process areas S₁₁, S₁₂, . . . . S₁₆ are situated in the manufacturing line P₁. When the object to be manufactured is a semiconductor device, the multiple processes include coating, exposure, development, etching, cleaning, implantation of impurities, film forming, and heat treatment processes for semiconductor substrates. A number of the process areas S included in each manufacturing line P can be freely changed depending on the object to be manufactured.

One or more resource E from a resource group M is allocated to each process area S. The resource group M includes multiple resources E. When the object to be manufactured OB is a semiconductor device, each resource E is a semiconductor-manufacturing apparatus used to execute processing in the process. When the process is a coating process, the resource E includes a coating apparatus. When the process is an exposure process, the resource E includes an exposure apparatus. When the process is a development process, the resource E includes a developing apparatus. When the process is an etching process, the resource E includes an etching apparatus. When the process is a cleaning process, the resource E includes a cleaning apparatus. When the process is an implantation of impurities process, the resource E includes an ion implanter. When the process is a film forming process, the resource E includes a film forming apparatus. When the process is a heat treatment process, the resource E includes a heat treatment apparatus.

An object to be processed by the resource E for manufacturing a manufacturing object OB is referred to as a lot. The lot includes one or more substrates mounted on a FOUP (not illustrated). In the manufacturing line P, the lot mounted on the FOUP can be transferred between the resources E by equipment such as a transporting apparatus (not illustrated). The substrates are processed one by one by the resource E if the resource E is of a sheet-fed type and are processed in a lot unit by the resource E if the resource E is of a batch-fed type. Hereinafter, lots are to be processed by the resource E for simplicity.

In a case where the manufacturing object OB is a semiconductor device, the manufacturing line P can include multiple process areas S that can be re-entrant. For example, the multiple process areas S₁ to S₆ in the manufacturing line P₁ may include, as shown encircled with a dotted line in FIG. 1, multiple re-entrant process areas S₂ to S₅. The multiple process areas S₁₁ to S₁₆ in the manufacturing line P₂ may include, as shown encircled with a dotted line in FIG. 1, multiple re-entrant process areas S₁₂ to S₁₅.

In a case where the manufacturing object OB is a semiconductor device, the multiple process areas S can include a process area S that is compatible between multiple manufacturing lines P. For example, as shown encircled with a dot-and-dash line in FIG. 1, the process area S: in the manufacturing line P₁ and the process area S₁₁ in the manufacturing line P₂ are similar processes and execute similar details of processing, and thus may be capable of processing different lots corresponding to different manufacturing objects OB by the resource E using a common recipe.

The manufacturing line P can be provided with a stock B. The stock B is also named a buffer stocker and functions as a buffer to smooth out a difference and a variation between capacities of the resources E in the manufacturing line P. FIG. 1 illustrates an example in which the process areas S₂, S₄, and S₅ have stocks B₂, B₄, and B₅ in the manufacturing line P₁, and the process areas S₁₂, S₁₄, and S₁₅ have stocks B₁, B₁₄, and B₁₅ in the manufacturing line P₂.

A number of lots that the stock B is able to accommodate is referred to as a stock capacity, and the number of lots actually accommodated in the stock B is referred to as a stock quantity. FIG. 1 illustrates an example in which capacities of the stocks B₂, B₄, B₅, B₁₂, B₁₄, and B₁₅ are three lots, five lots, two lots, one lot, three lots, and one lot, respectively. FIG. 1 illustrates an example in which quantities of the stocks B₂, B₄, B₅, B₁₂, B₁₄, and B₁₅ are one lot, two lots, one lot, zero lots, one lot, and zero lots, respectively.

One of the manufacturing lines P will be primarily described hereinafter. However, the same applies to the other manufacturing lines P.

One or more resource E from the resource group M is allocated to each process area S. The resource group M includes multiple resources Ei. i is an identifier of the resource E and may be an integer greater than or equal to 1. When the object to be manufactured is a semiconductor device, each resource E is a semiconductor-manufacturing apparatus used to execute processing in the process. When the process is a coating process, the resource E includes a coating apparatus. When the process is an exposure process, the resource E includes an exposure apparatus. When the process is a development process, the resource E includes a developing apparatus. When the process is an etching process, the resource E includes an etching apparatus. When the process is a cleaning process, the resource E includes a cleaning apparatus. When the process is an implantation of impurities process, the resource E includes an ion implanter. When the process is a film forming process, the resource E includes a film forming apparatus. When the process is a heat treatment process, the resource E includes a heat treatment apparatus.

The manufacturing line P has a norm t to be reached. The norm t indicates a production volume (for example, the number of substrates) that is to be output from the manufacturing line P per unit time. The unit time may be 1 day. The norms of the process areas S₁ to S_{Q} may be level with the norm t of the manufacturing line P. A difference in time required for processing among the multiple process areas S₁ to S_{Q} can be smoothed out by changing the number of resources allocated to each of the process areas S₁ to S_{Q}.

Since the capacity of the resource E and a job inflow into the resource E vary in the manufacturing line P, a throughput of the manufacturing line P changes over time. This can cause a lengthy lot stay in the middle and cause a throughput of the downstream process to be lower than a throughput of the upstream process. The capacity of the resource E is a rate of job processing by the resource E and represents the number of jobs (for example, the number of substrates) that the resource E is able to process per unit time. The job is a target object (for example, a substrate) to be processed by the resource E. The unit time may be 1 day. The job inflow represents the number of jobs input to the resource E per unit time. The throughput of the manufacturing line P represents the number of jobs output by the manufacturing line P per unit time.

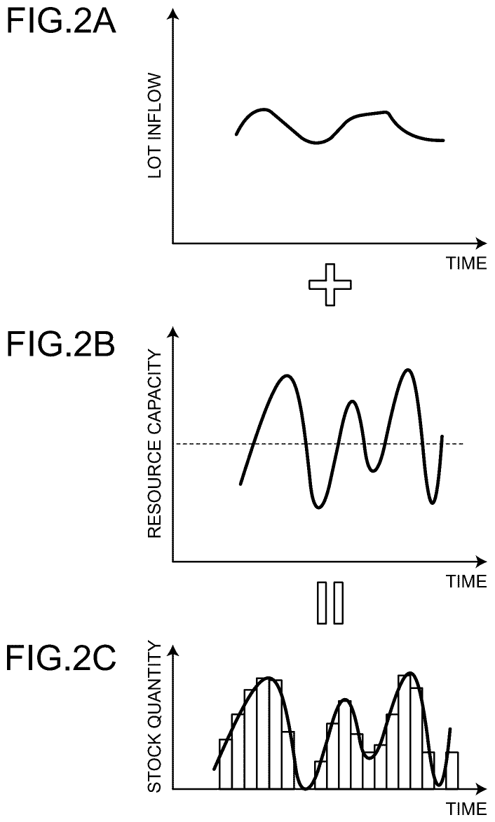

In each process area S for the manufacturing line P, for example, the lot inflow changes over time as illustrated in FIG. 2A, and the capacity of the resource E changes over time as illustrated in FIG. 2B. In response to this, the quantity of stock on the resource E changes over time as illustrated in FIG. 2C. FIGS. 2A to 2C are diagrams illustrating fluctuations in lot inflow, resource capacity, and resource stock quantity. A way that the lot inflow, the resource capacity, and the resource stock quantity fluctuate can vary among the multiple resources E in the manufacturing line P.

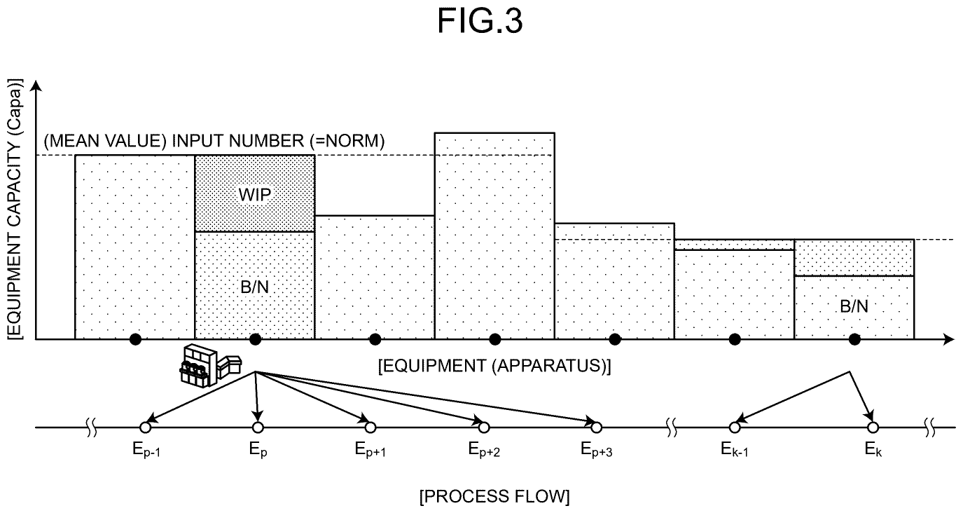

As illustrated in FIG. 3, in addition to variation from the norm t due to the fluctuations in lot inflow, the capacity of the resource E, and resource stock quantity, a mean value of the norm t, on which the variation is based, can change. FIG. 3 is a diagram illustrating an unsteady change in norm.

In the manufacturing line P, the throughput of the downstream process can be lower than the throughput of the upstream process. This and other factors can cause the mean value of the norm t for the upstream process to be lower than the mean value of the norm t for the downstream process. From the viewpoint of the manufacturing line P as a whole, it is desirable to manage the manufacturing line by taking into account the fact that the mean value of the norm t does not converge over time but changes unsteadily.

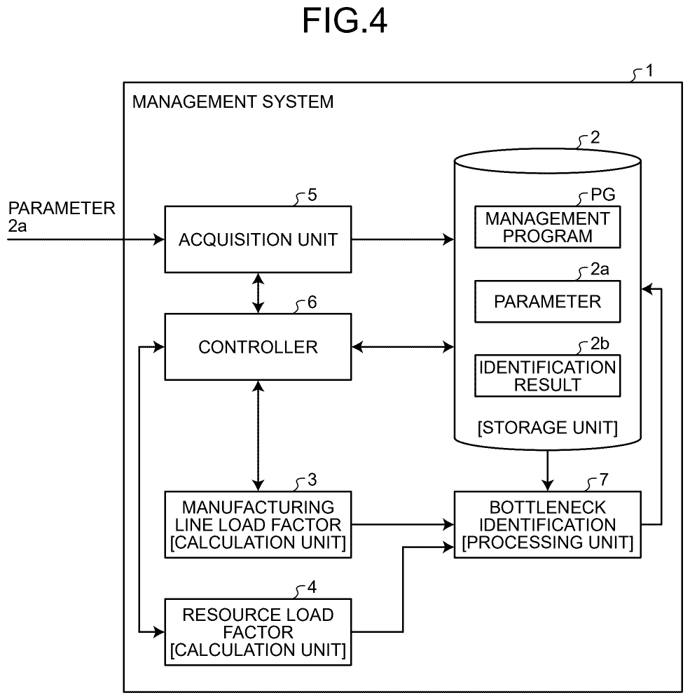

Each of the manufacturing lines P as illustrated in FIGS. 1 to 3 can be managed by a management system 1 illustrated in FIG. 4. FIG. 4 is a diagram illustrating a functional configuration of the management system 1.

The management system 1 determines a variation characteristic of a load factor of the manufacturing line P. The management system 1 determines a variation characteristic of a load factor of each of the multiple resources E in the manufacturing line P. The management system 1 identifies the resource E that is to be improved out of the multiple resources E in the manufacturing line P in response to the variation characteristic of the load factor of the manufacturing line P and the variation characteristic of the load factor of each of the resources E.

At this time, the management system 1 may perform management that takes into consideration an unsteady change in the norm t and applies the idea of a non-homogeneous Poisson process.

The management system 1 includes a controller 6, an acquisition unit 5, a storage unit 2, a calculation unit 3, a calculation unit 4, and a processing unit 7 in terms of function.

The storage unit 2 stores a management program PG. The management program PG includes multiple processes to perform predetermined management. The predetermined management includes management for identifying the resource E that is to be improved in each manufacturing line P.

By following the management program PG, the controller 6 centrally controls each unit of the management system 1. The controller 6 is able to manage multiple periods T1 to Tn subject to processing. The controller 6 may control each unit of the management system 1 to execute processing for the multiple periods T1 to Tn. A length of each period T is determined in advance as a length appropriate for managing each manufacturing line P. The length of each period T may be 1 day.

Under control of the controller 6, the acquisition unit 5 acquires a parameter 2a. The parameter 2a includes the number of lots input to the manufacturing line P, the number of lots output from the manufacturing line P, an operating rate of each resource E in the manufacturing line P, operational availability of each resource E in the manufacturing line P, and a period for which these values are acquired. The acquisition unit 5 may acquire the parameter 2a in response to input from a user. The acquisition unit 5 may acquire the parameter 2a through a communication medium such as a wired communications line or a radio communications line. Under control of the controller 6, the storage unit 2 may receive the parameter 2a from the acquisition unit 5 and store the parameter as a database. The database includes input number information, output number information, operating rate information, and operational availability information. The input number information is information in which the period, the number of input lots, and an identifier of the manufacturing line P are related to each other with regard to the multiple manufacturing lines P. The input number information corresponds to the number of lots input to the manufacturing line P. The output number information is information in which the period, the number of output lots, and the identifier of the manufacturing line P are related to each other with regard to the multiple manufacturing lines P. The number of output lots corresponds to the number of lots output from the manufacturing line P. The operating rate information is information in which the period, the operating rate, the identifier of the manufacturing line P, and the identifier of the resource E are related to each other with regard to the multiple manufacturing lines P and the multiple resources E. The operational availability information is information in which the period, the operational availability, the identifier of the manufacturing line P, and the identifier of the resource E are related to each other with regard to the multiple manufacturing lines P and the multiple resources E.

The storage unit 2 may store an identification result 2b identified by the processing unit 7. The identification result 2b includes bottleneck information. The bottleneck information is information concerning the resource E that constitutes a bottleneck in the manufacturing line P. The bottleneck information may be information in which the identifier of the manufacturing line P and the identifier of the resource E are related to each other with regard to the multiple manufacturing lines P.

The calculation unit 3 may determine the load factor of the manufacturing line P in view of the non-homogeneous Poisson process.

According to a theory of the non-homogeneous Poisson process, for example, an unsteady change in Pn(t) over time is represented by a differential Formula of the following Formula 1 or 2, where Pn(t) is a probability of n pieces of lots being present in a system; λ(t) is a rate of lots being input into the system; and μ(t) is a rate of lots being output from the system. Formula 1 is a differential Formula for n≥1, and Formula 2 is a differential Formula for n=0.

$$\frac{d}{dt} {P}_{n ( t )} = {λ}_{( t )} \cdot {P}_{n - 1 ( t )} - ( {λ}_{( t )} + {μ}_{( t )} ) \cdot {P}_{n ( t )} + {μ}_{( t )} \cdot {P}_{n + 1 ( t )} … n \geq 1 \qquad Formula 1$$

$$\frac{d}{dt} \text{?} = - {λ}_{( t )} \cdot \text{?} + {μ}_{( t )} \cdot {P}_{1 ( t )} … n = 0 \qquad Formula 2$$

$$\text{?} \text{indicates text missing or illegible when filed}$$

Provided that the initial condition is Formula 3 shown below:

$$initial condition : {P}_{n ( 0 )} = {δ}_{n} , 0 \qquad Formula 3$$

When the differential Formula of Formula 1 or 2 is solved, Pn(t), the probability of n pieces of lots being present in the system, is as given by the following Formula 4:

$$\text{?} = exp [ - λ - μ ] \cdot \text{?} \cdot \text{?} ( \text{?} λμ ) + exp [ - λ - μ ] \cdot \text{?} \cdot \text{?} ( \text{?} λμ ) + exp [ - λ - μ ] \cdot ( 1 - ρ ) \cdot \text{?} \cdot {\sum }_{k = ( n + 2 )}^{∞} \text{?} \cdot \text{?} ( \text{?} λμ ) \qquad Formula 4$$

$$\text{?} \text{indicates text missing or illegible when filed}$$

In Formula 4, In(z) is a modified Bessel function. Formula 4 indicates that the probability Pn(t) changes unsteadily over time depending on the lot input rate λ(t) and the lot output rate μ(t).

With reference to Formula 4, the system load factor P(t) can be represented by the following Formula 5:

$${P}_{( t )} = \frac{{Λ}_{( t )}}{{M}_{( t )}} \qquad Formula 5$$

In Formula 5, ∇(t) represents the number of lots input to the system and can be determined by integrating the lot input rate λ(t) with respect to time, as shown in the following Formula 6:

$${Λ}_{( t )} = {\int }_{0}^{t} {λ}_{( t )} {d}_{t} \qquad Formula 6$$

In Formula 5, M(t) represents the number of lots output from the system and can be determined by integrating the lot output rate μ(t) with respect to time, as shown in the following Formula 7:

$${M}_{( t )} = {\int }_{0}^{t} {μ}_{( t )} {d}_{t} \qquad Formula 7$$

Through application of Formulas 5 to 7, the calculation unit 3 may determine a load factor ρi of the manufacturing line P for a period Ti using the following Formula 8. i is any integer from 1 to n inclusive.

$${ρ}_{i} = \frac{{A}_{i}}{{M}_{i}} \qquad Formula 8$$

In Formula 8, Ai represents the number of lots input to the manufacturing line P, and Mi represents the number of lots output from the manufacturing line P.

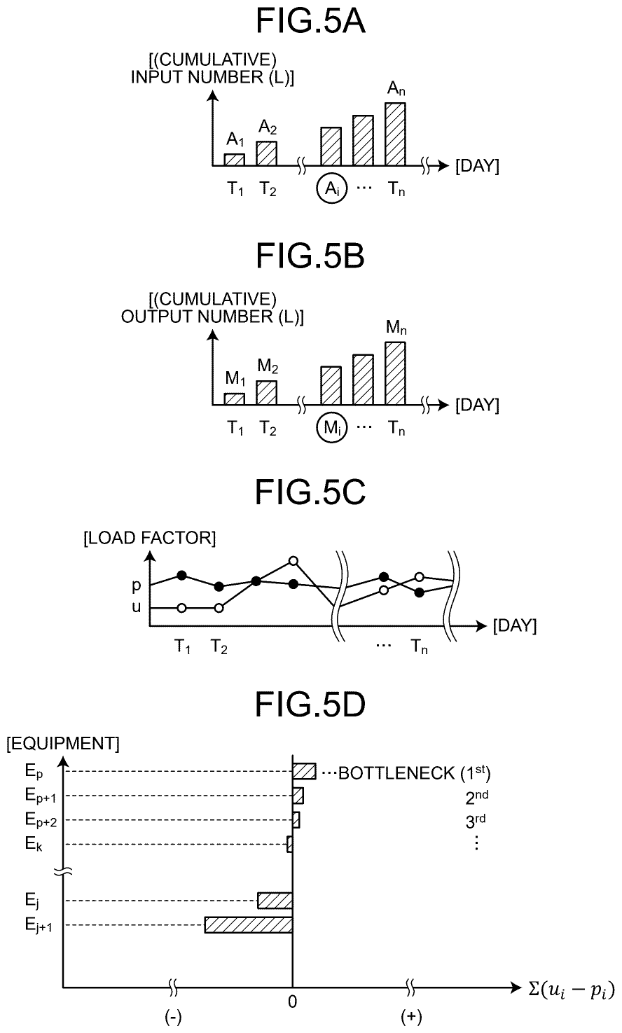

The calculation unit 3 acquires the input number information and the output number information from the storage unit 2 through the controller 6. FIGS. 5A to 5D are diagrams illustrating an outline of a procedure for determining the resource E that is to be improved. As illustrated in FIG. 5A, the calculation unit 3 extracts, from the input number information, multiple sets of the periods T1 to Tn and the numbers of input lots A1 to An corresponding to the identifier of the manufacturing line P of interest. As illustrated in FIG. 5B, the calculation unit 3 extracts, from the output number information, multiple sets of the periods T1 to Tn and the numbers of output lots M1 to Mn corresponding to the identifier of the manufacturing line P of interest. The calculation unit 3 may, as illustrated in FIG. 5C, determine the load factor ρi of the manufacturing line P in relation to the number of lots Ai input to the manufacturing line P and the number of lots Mi output from the manufacturing line P for each of the multiple periods Ti (i=1, 2, . . . , n). n is any integer greater than or equal to 3. The calculation unit 3 may divide the number of input lots Ai by the number of output lots Mi for each period Ti to determine the load factor ρi of the manufacturing line P.

It should be noted that the load factor ρi of the manufacturing line P correlates highly with the norm t of the manufacturing line P. By detecting an unsteady change in load factor ρi of the manufacturing line P, an unsteady change in norm t of the manufacturing line P can be detected. The load factors ρ1, ρ2, . . . , ρn of the manufacturing line P for the multiple respective periods T1, T2, . . . , Tn can be regarded as a parameter that shows an unsteady change in load factor ρi of the manufacturing line P.

The calculation unit 3 feeds the load factors ρ1, ρ2, . . . , ρn of the manufacturing line P for the multiple respective periods T1, T2, . . . , Tn to the processing unit 7.

The calculation unit 4 may determine a variation characteristic of the load factor of each of the multiple resources E in view of the non-homogeneous Poisson process.

Through application of Formulas 5 to 7, for example, the calculation unit 4 may determine a load factor ui of the resource E for the period Ti using the following Formula 9.

$${u}_{i} = \frac{{r}_{i}}{{m}_{i}} \qquad Formula 9$$

In Formula 9, ri represents the operating rate of the resource E, and mi represents operational availability of the resource E.

The calculation unit 4 acquires the operating rate information and the operational availability information from the storage unit 2 through the controller 6. The calculation unit 4 extracts, from the operating rate information, multiple sets of the periods T1 to Tn and the operating rates r1 to rn corresponding to the identifier of the resource E of interest. The calculation unit 3 extracts, from the operational availability information, multiple sets of the periods T1 to Tn and the operational availability m1 to mn corresponding to the identifier of the resource E of interest. The calculation unit 4 may, as illustrated in FIG. 5C, determine the load factor ui of the resource E in relation to the operating rate ri of the resource E and the operational availability mi of the resource E for each of the multiple periods Ti (i=1 to n). The calculation unit 4 may divide the operating rate ri by the operational availability mi for each period Ti to determine the load factor ui of the resource E.

The calculation unit 4 feeds the load factors u1, u2, . . . , un of the resource E for the multiple respective periods T1, T2, . . . , Tn to the processing unit 7.

The processing unit 7 determines a variation characteristic of a difference between the load factor ui of the resource E and the load factor ρi of the manufacturing line P with regard to each of the multiple resources E. The processing unit 7 may subtract the load factor ρi of the manufacturing line P from the load factor ui of the resource E to determine a difference (ui−ρi) for each of the multiple periods T1 to Tn with regard to each of the multiple resources E.

The processing unit 7 applies statistical processing to the variation characteristic of the difference. The processing unit 7 may add up each of the differences (ui−ρi) for the multiple periods Ti (i=1 to n) with regard to each of the multiple resources E.

The processing unit 7 may, for example, subtract the load factor of the manufacturing line P from the load factor of the resource E to determine a total of the differences (ui−ρi) for the periods Ti using the following Formula 10.

$${\sum }_{i = 1}^{n} ( {u}_{i} - {ρ}_{i} ) \qquad Formula 10$$

The processing unit 7, in response to a result of the statistical processing, identifies the resource E that constitutes a bottleneck out of the multiple resources E. The resource E that constitutes a bottleneck refers to the resource E for which a lot stays lengthily. As illustrated in FIG. 5D, the processing unit 7 may designate the resource E that has a largest amount of the added up differences Σ (ui−ρi) as the resource E that constitutes a bottleneck out of the multiple resources E. FIG. 5D exemplifies a case in which the resource Ep is the resource that constitutes a bottleneck. The processing unit 7 puts the identification result 2b, which shows the resource E that constitutes a bottleneck, in the storage unit 2.

Hence, the storage unit 2 stores the identification result 2b concerning the resource E that constitutes a bottleneck in each manufacturing line P. In response to the identification result 2b stored in the storage unit 2, or such an event as a request from the user, the controller 6 may inform, by visual and/or auditory means, the user of the identification result 2b concerning the resource E that constitutes a bottleneck in each manufacturing line P.

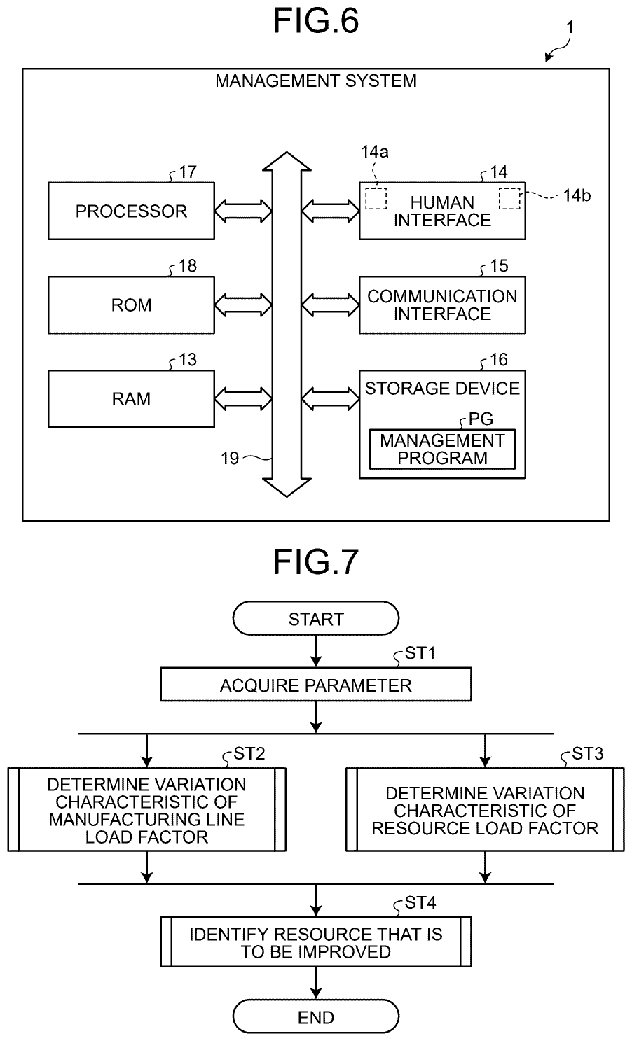

As illustrated in FIG. 6, the management system 1 includes a processor 17, read only memory (ROM) 18, random-access memory (RAM) 13, a human interface 14, a communication interface 15, a storage device 16, and a bus 19 in terms of hardware configuration.

The processor 17 includes a central processing unit (CPU) and the like. The processor 17 corresponds to the controller 6, the calculation unit 3, the calculation 4, and the processing unit 7. When the management program PG is executed by the processor 17, the controller 6, the calculation unit 3, the calculation 4, and the processing unit 7 are deployed on the RAM 13 collectively during compilation or sequentially in response to progress in processing to be constituted functionally.

The ROM 18 stores permanent data. The ROM 18 is equivalent to the storage unit 2.

The RAM 13 is designed to store information temporarily and provides a work area and the like for the processor 17. The RAM 13 is equivalent to the storage unit 2.

The human interface 14 acts as an intermediary between a human and a computer. The human interface 14 has an input device 14a and an output device 14b.

The input device 14a includes such a device as a keyboard, a mouse, and a touch panel designed to accept a request from the human. The input device 14a is equivalent to the acquisition unit 5.

The output device 14b is such a device as a display, a printer, a display unit, and a speaker designed to output visual and/or auditory information to the human.

The communication interface 15 is designed to connect to an external device through a communication medium. When connected to the external device through the communication medium, the communication interface 15 can receive information from or send information to the external device.

The storage device 16 is such a nonvolatile storage device as a hard disk drive (HDD) or a solid-state drive (SSD) designed to store information. The storage device 16 stores programs to allow the processor 17 to operate as well as various kinds of data. The storage device 16 may store the management program PG. The storage device 16 is equivalent to the storage unit 2.

The processor 17, the ROM 18, the RAM 13, the human interface 14, the communication interface 15, and the storage device 16 are connected together such that these units can communicate with one another through the bus 19.

With reference to FIG. 7, an outline of an operation conducted by the management system 1 will now be described. FIG. 7 is a flowchart illustrating the outline of the operation conducted by the management system 1.

The acquisition unit 5 in the management system 1 acquires the parameter 2a (ST1). The acquisition unit 5 acquires the parameter 2a, for example, in response to input from the user or through a communication medium such as a wired communications line or a radio communications line. The parameter 2a includes the number of lots input to the manufacturing line P, the number of lots output from the manufacturing line P, an operating rate of each resource E in the manufacturing line P, operational availability of each resource E in the manufacturing line P, and a period for which these values are acquired. The storage unit 2 may receive the parameter 2a from the acquisition unit 5 and store the parameter as a database. The database includes input number information, output number information, operating rate information, and operational availability information.

When the parameter 2a is acquired, ST2 and ST3 are performed concurrently.

In ST2, the calculation unit 3 determines a variation characteristic of the load factor of the manufacturing line P. The calculation unit 3 may determine the load factor of the manufacturing line P in view of the non-homogeneous Poisson process.

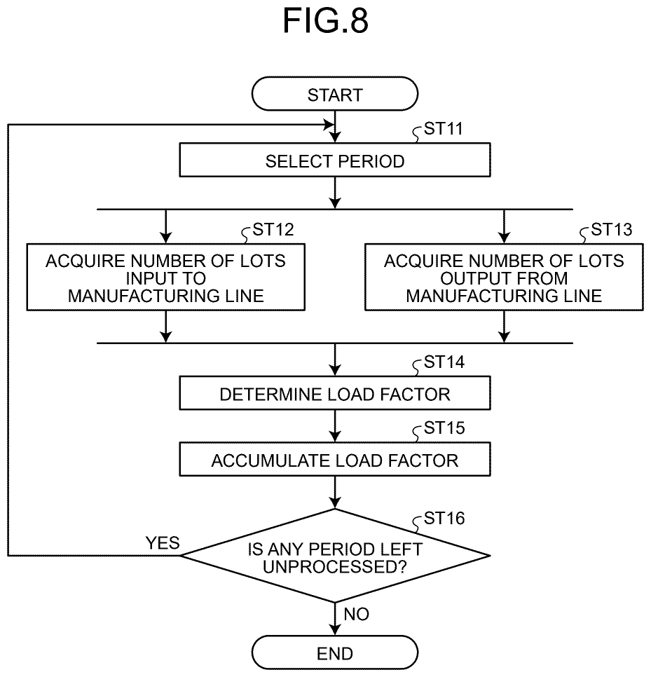

In ST2, ST11 to ST16 illustrated in FIG. 8, for example, may be performed. FIG. 8 is a flowchart illustrating a process for determining a variation characteristic of the load factor of the manufacturing line P.

The calculation unit 3 acquires the input number information and the output number information from the storage unit 2 through the controller 6 and selects a period T subject to processing out of the multiple periods T1, T2, . . . , Tn (ST11). When the period T subject to processing is selected, the calculation unit 3 performs ST12 and ST13 concurrently.

In ST12, the calculation unit 3 acquires the number of lots input to the manufacturing line P. The calculation unit 3 may extract, from the input number information, the number of input lots corresponding to the identifier of the manufacturing line P of interest and the period T subject to processing to acquire the number of lots input to the manufacturing line P.

In ST13, the calculation unit 3 acquires the number of lots output from the manufacturing line P. The calculation unit 3 may extract, from the output number information, the number of output lots corresponding to the identifier of the manufacturing line P of interest and the period T subject to processing to acquire the number of lots output from the manufacturing line P.

When both ST12 and ST13 are completed, the calculation unit 3 determines the load factor ρi of the manufacturing line P in relation to the number of lots Ai input to the manufacturing line P and the number of lots Mi output from the manufacturing line P for the period T subject to processing (ST14). The calculation unit 3 may divide the number of input lots Ai by the number of output lots Mi for the period Ti subject to processing to determine the load factor ρi of the manufacturing line P.

The calculation unit 3 accumulates the determined load factor ρi in association with the period Ti subject to processing (ST15).

If there is the period T that is left unprocessed out of the multiple periods T1, T2, . . . , Tn (Yes in ST16), the calculation unit 3 returns the processing to S₁₁.

If there is not any period T that is left unprocessed (No in ST16), the calculation unit 3 feeds the load factors ρ1, ρ2, . . . , ρn of the manufacturing line P for the multiple respective periods T1, T2, . . . , Tn to the processing unit 7 and ends the processing.

In ST3, the calculation unit 4 determines a variation characteristic of the load factor of each of the multiple resources E. The calculation unit 4 may determine the load factor of each of the multiple resources E in view of the non-homogeneous Poisson process.

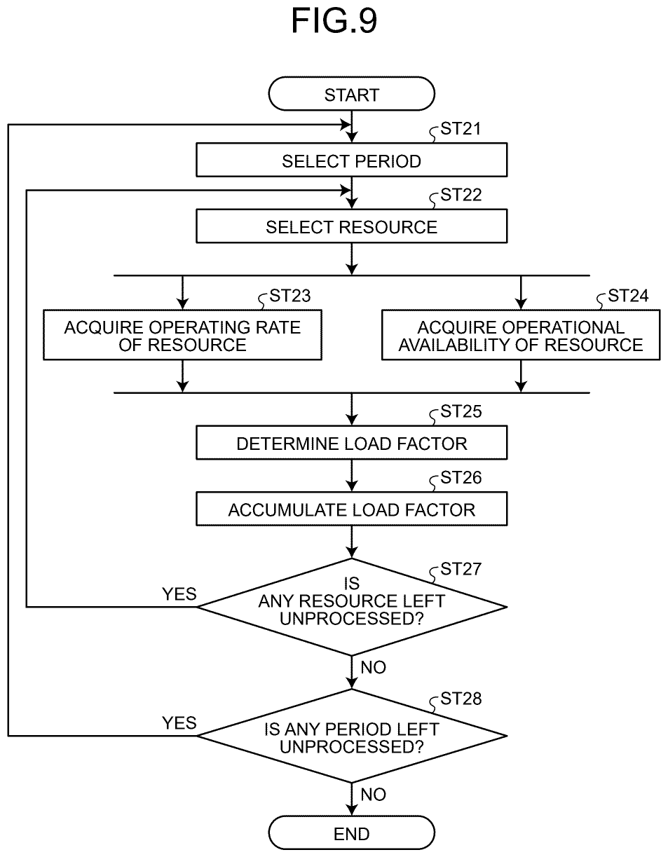

In ST3, ST21 to ST28 illustrated in FIG. 9, for example, may be performed. FIG. 9 is a flowchart illustrating a process for determining a variation characteristic of the load factor of each of the multiple resources E.

The calculation unit 4 acquires the operating rate information and the operational availability information from the storage unit 2 through the controller 6 and selects a period T subject to processing out of the multiple periods T1, T2, . . . , Tn (ST21).

The calculation unit 4 selects a resource E subject to processing out of the multiple resources E (ST22).

When the period T subject to processing and the resource E subject to processing are selected, the calculation unit 4 performs ST23 and ST24 concurrently.

In ST23, the calculation unit 4 acquires the operating rate ri of the resource E. The calculation unit 4 may extract, from the operating rate information, an operating rate corresponding to the identifier of the manufacturing line P of interest, the period T subject to processing, and the resource E subject to processing to acquire the operating rate ri of the resource E.

In ST24, the calculation unit 4 acquires the operational availability mi of the resource E. The calculation unit 4 may extract, from the operational availability information, operational availability corresponding to the identifier of the manufacturing line P of interest, the period T subject to processing, and the resource E subject to processing to acquire the operational availability mi of the resource E.

When both ST23 and ST24 are completed, the calculation unit 4 determines the load factor ui of the resource E in relation to the operating rate ri of the resource E and the operational availability mi of the resource E for the period T subject to processing and the resource E subject to processing (ST25). The calculation unit 4 may divide the operating rate ri by the operational availability mi for the period Ti subject to processing and the resource E subject to processing to determine the load factor ui of the resource E.

The calculation unit 4 accumulates the determined load factor ui in association with the period Ti subject to processing and the resource E subject to processing (ST26).

If there is the resource E that is left unprocessed out of the multiple resources E (Yes in ST27), the calculation unit 4 returns the processing to ST22.

If there is not any resource E that is left unprocessed (No in ST27) and if there is the period T that is left unprocessed out of the multiple periods T1, T2, . . . , Tn (Yes in ST28), the calculation unit 4 returns the processing to ST21.

If there is not any resource E that is left unprocessed (No in ST27) and if there is not any period T that is left unprocessed (No in ST28), the calculation unit 4 feeds the load factors u1, u2, . . . , un of each of the multiple resources E for the multiple respective periods T1, T2, . . . , Tn to the processing unit 7 and ends the processing.

When both ST2 and ST3 are completed, the processing unit 7 identifies the resource E that is to be improved out of the multiple resources E in the manufacturing line P (ST4) in response to the variation characteristic of the load factor of the manufacturing line P determined in ST2 and the variation characteristic of the load factor of the resources E determined in ST3.

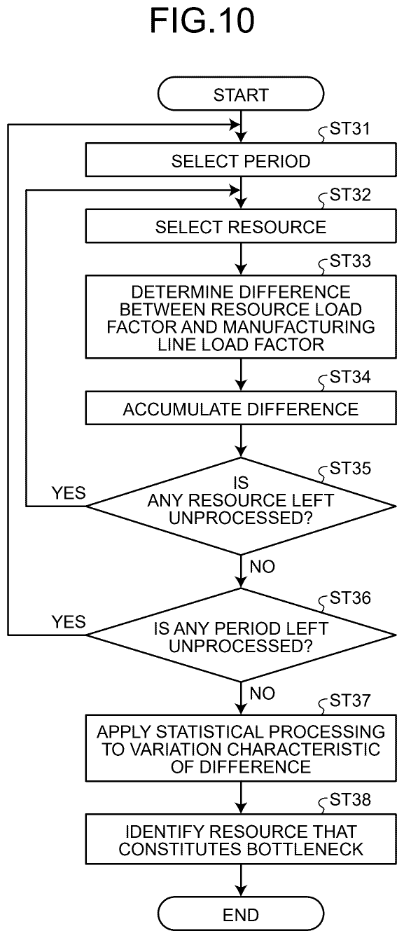

In ST4, ST31 to ST38 illustrated in FIG. 10, for example, may be performed. FIG. 10 is a flowchart illustrating a process for identifying the resource E that is to be improved.

The processing unit 7 acquires the load factors ρ1, ρ2, . . . , ρn of the manufacturing line P for the multiple respective periods T1, T2, . . . , Tn from the calculation unit 3. The processing unit 7 acquires the load factors u1, u2, . . . , un of each of the multiple resources E for the multiple respective periods T1, T2, . . . , Tn from the calculation unit 4.

The processing unit 7 selects a period T subject to processing out of the multiple periods T1, T2, . . . , Tn (ST31).

The processing unit 7 selects a resource E subject to processing out of the multiple resources E (ST32).

When the period T subject to processing and the resource E subject to processing are selected, the processing unit 7 determines a difference between the load factor ui of the resource E and the load factor ρi of the manufacturing line P for the period Ti subject to processing and the resource E subject to processing (ST33). The processing unit 7 may subtract the load factor ρi of the manufacturing line P from the load factor ui of the resource E to determine the difference (ui−ρi).

The processing unit 7 accumulates the determined difference (ui−ρi) in association with the period Ti subject to processing and the resource E subject to processing (ST34).

If there is the resource E that is left unprocessed out of the multiple resources E (Yes in ST35), the processing unit 7 returns the processing to ST32.

If there is not any resource E that is left unprocessed (No in ST35) and if there is the period T that is left unprocessed out of the multiple periods T1, T2, . . . , Tn (Yes in ST36), the processing unit 7 returns the processing to ST31.

If there is not any resource E that is left unprocessed (No in ST35) and if there is not any period T that is left unprocessed (No in ST36), the processing unit 7 applies statistical processing to the variation characteristic of the difference (ui−ρi) (ST37). The processing unit 7 may add up each the differences (ui−ρi) for the multiple periods Ti (i=1 to n) with regard to each of the multiple resources E.

The processing unit 7, in response to a result of the statistical processing, identifies the resource E that constitutes a bottleneck out of the multiple resources E (ST38). The processing unit 7 may designate the resource E that has a largest amount of the added up differences Σ (ui−ρi) as the resource E that constitutes a bottleneck out of the multiple resources E. The processing unit 7 puts the identification result 2b, which shows the resource E that constitutes a bottleneck, in the storage unit 2.

As described above, in the first embodiment, by the method of managing the manufacturing line P, the resource E that is to be improved is identified out of the multiple resources E in the manufacturing line P in response to the variation characteristic of the load factor of the manufacturing line P and the variation characteristic of the load factor of the resources E. For example, the management system subtracts the load factor ρi of the manufacturing line P from the load factor ui of the resource E to determine a difference (ui−ρi) for each of the multiple periods T1 to Tn, adds up each of the differences (ui−ρi) for the multiple periods Ti (i=1 to n), and designates the resource E that has the largest amount of the added up differences Σ (ui−ρi) as the resource E that constitutes a bottleneck. This makes it possible to identify the resource E that is to be improved out of the multiple resources E in the manufacturing line P while taking into consideration an unsteady change in norm t of the manufacturing line P and inform the user of the identified resource E. This makes it possible to encourage the user to improve the resource E that is to be improved. This method, therefore, may help to effectively suppress a loss in operation of the resource E in the process area S for each manufacturing line P and efficiently process the lots.

### Second Embodiment

A method of managing a manufacturing line according to a second embodiment will now be described. Differences from the first embodiment will be primarily described below.

In the first embodiment, the process for identifying the resource E that is to be improved is exemplified. In the second embodiment, a process for appropriately coordinating multiple priorities will be exemplified.

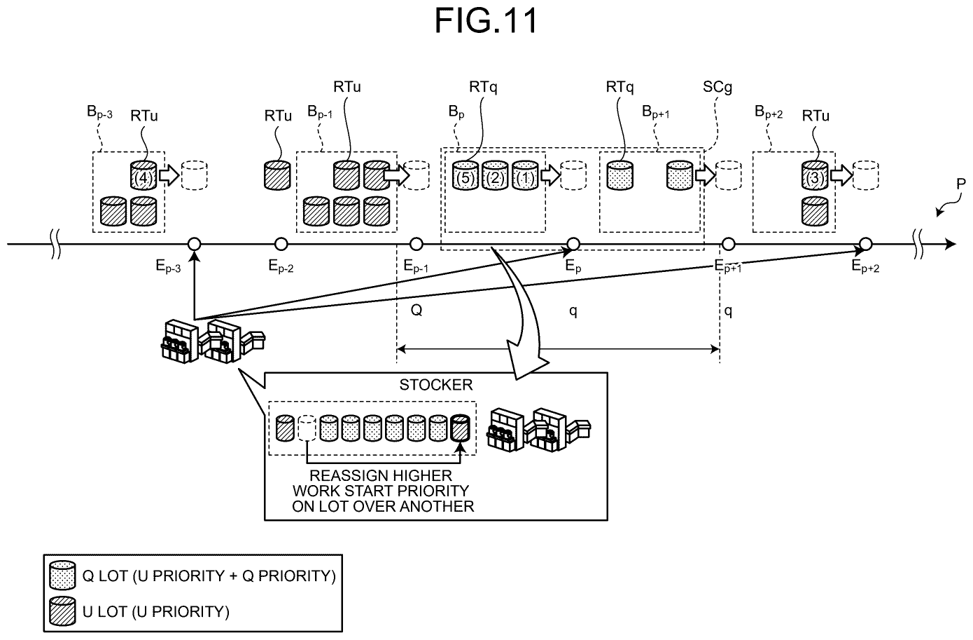

In a manufacturing line P, lots RT to be processed by resources Eₚ₋₃ to Eₚ₊₂ can stay in stocks Bₚ₋₃ to Both, and various priorities are assigned to these lots. For example, a Q priority and a U priority (critical ratio) are assigned to Q lots RTq illustrated without hatching in FIG. 11. The Q priority is not assigned to U lots RTu illustrated by hatching in FIG. 11, and the U priority is assigned to these lots. FIG. 11 is a diagram illustrating an outline of coordination between the Q priority and the U priority according to the second embodiment.

The U priority is a priority relating to delivery urgency. A higher level of the priority is set in response to an increase in degree of delay relative to a work period that is allocated to each process in accordance with a deadline for delivery.

The Q priority is a priority relating to quality and is established to meet a Q-time constraint.

The Q-time constraint is a constraint placed on a length of stay in a constrained section to satisfy demand for quality. The Q-time constraint includes a time constraint Tq on the length of stay in the constrained section. The lot RT that cannot meet the Q-time constraint may be reworked or discarded. In the manufacturing line P illustrated in FIG. 11, a constrained section SCq including the stock Bp for the resource Ep and the stock Bp+1 for the resource Ep+1 is provided, and the length of stay in the constrained section SCq is required to be less than or equal to the time constraint Tq.

For example, if the length of stay of the Q lot RTq in the constrained section SCq is not well inside of the time constraint Tq, it is appropriate to process the Q lot RTq prior to the U lot RTu by the resource E.

On the other hand, if the length of stay of the Q lot RTq in the constrained section SCq is well inside of the time constraint Tq, it may not be appropriate to process the Q lot RTq prior to the U lot RTu by the resource E. It is desirable to appropriately coordinate the Q priority and the U priority in the manufacturing line P.

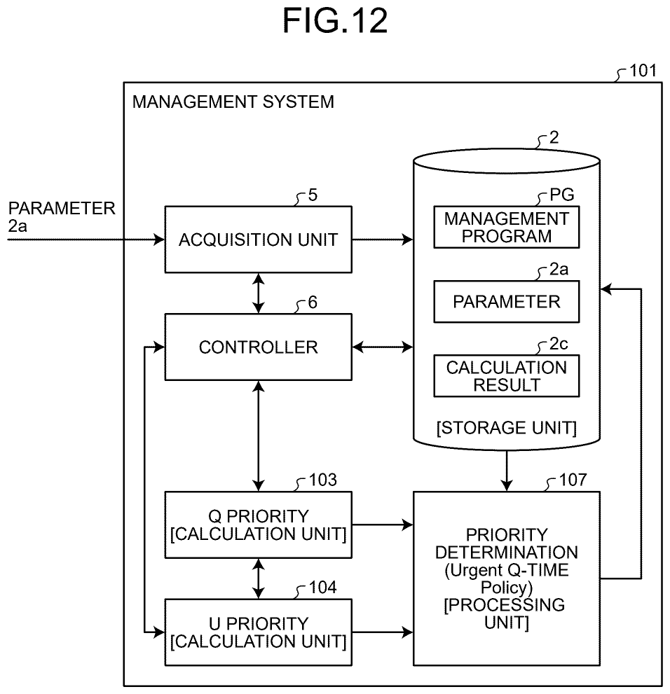

Each manufacturing line P as illustrated in FIG. 11 may be managed by a management system 101 illustrated in FIG. 12. FIG. 12 is a diagram illustrating a functional configuration of the management system 101.

The management system 101 identifies the lot RT to which the Q priority is assigned and the lot RT to which the U priority is assigned out of the multiple lots RT that can be processed by the resource E. In response to a result of the identified lots, the management system 101 determines the lot RT that is to be preferentially processed by the resource E out of the multiple lots RT.

At this time, the management system 101 implements the “Urgent Q-TIME Policy”, a priority determination algorithm that takes delivery urgency into consideration while meeting the Q-time constraint. This makes it possible to appropriately coordinate the Q priority and the U priority in the manufacturing line P.

The management system 101 includes a calculation unit 103, a calculation unit 104, and a processing unit 107 rather than the calculation unit 3, the calculation unit 4, and the processing unit 7 (refer to FIG. 4).

Under control of the controller 6, the acquisition unit 5 acquires a parameter 2a. The parameter 2a further includes the lots RT that are in process on the resources E in the manufacturing line P, a deadline for delivery of each lot, and the Q-time constraint.

Under control of the controller 6, the storage unit 2 may receive the parameter 2a from the acquisition unit 5 and store the parameter as a database. The database further includes in-process information, deadline information, and Q-time constraint information. The in-process information is information in which an identifier of the lot in process, an identifier of the manufacturing line P, and an identifier of the resource E are related to each other with regard to the multiple resources E. The deadline information is information in which the deadline for delivery and the identifier of the lot are related to each other with regard to the multiple lots RT. The Q-time constraint information is information in which the time constraint, the identifier of the manufacturing line P, and the identifiers of the resources E associated with the constrained section SCq are related to each other.

The calculation unit 103 acquires the in-process information, the deadline information, and the Q-time constraint information from the storage unit 2. The calculation unit 103, based on the in-process information and the Q-time constraint information, determines a level of the Q priority for at least one lot RT out of the multiple lots RT that can be processed by the resource E with regard to each resource E in the manufacturing line P. The at least one lot RT includes a Q lot RTq. The calculation unit 103 may determine the level of the Q priority in association with the identifier of the manufacturing line P, the identifier of the resource E, and the identifier of the lot RT.

The calculation unit 103, based on the in-process information and the Q-time constraint information, identifies the lot RT on which the Q-time constraint is placed out of the multiple lots RT that can be processed by the resource E. The calculation unit 103, based on the deadline information and the Q-time constraint information, determines the level of the Q priority for the lot RT in response to a remaining time of the work period for the lot RT relative to the time constraint. The calculation unit 103 may determine the level of the Q priority (Qi) for each lot RT that is in process on the resource Ei using the following Formula 11.

$$\begin{matrix}Qi = ( remaining work period ) / ( remaining time ) \\ = ( remaining work period ) / \{ ( set work period ) - \\ ( elapsed time ) \} \\ = \frac{{t}_{i} + f ( {t}_{i + 1} + … + {t}_{M} )}{f ( {t}_{2} + … + {t}_{M} ) - {T}_{i}}\end{matrix} \qquad Formula 11$$

In Formula 11, M indicates a number of processes within the constrained section SCq. ti indicates a processing time in the i_th process. f(tᵢ₊₁+ . . . +t_{M}) indicates a time constraint on the remaining processes in the constrained section SCq in relation to a processing time in the i+1_th to the M_th processes. f(t₂+ . . . +t_{M}) indicates a time constraint on all the processes in the constrained section SCq in relation to a processing time in the 2nd to the M_th processes. Ti is a length of stay in the constrained section SCq.

The calculation unit 103 feeds the level of the Q priority for each lot RT that is to be processed by any one resource E to the processing unit 107.

The calculation unit 104 acquires the in-process information and the deadline information from the storage unit 2. The calculation unit 104, based on the in-process information and the deadline information, determines levels of the U priority for the multiple respective lots RT that are in process on the resource E with regard to each resource E in the manufacturing line P. The multiple lots RT include at least a U lot RTu and may further include a Q lot RTq. The calculation unit 104 may determine the levels of the U priority in association with the identifier of the manufacturing line P, the identifier of the resource E, and the identifiers of the respective lots RT.

The calculation unit 104 may determine the level of the U priority in response to a degree of progress on the lot RT relative to the deadline for delivery with regard to each of the multiple lots RT. The calculation unit 104 may determine the level of the U priority (U) using the following Formula 12.

$$U = A \frac{x}{t} \qquad Formula 12$$

In Formula 12, A indicates a time in relation to an average processing time per single process and may include an allowance in addition to the average processing time. x indicates a number of remaining processes. t indicates a remaining time.

In view of the fact that a total of the processes in the manufacturing line P is long and that mean field approximation is applicable to a local variation, the calculation unit 104 may determine progress in processing of the lot RT by mean field approximation.

For example, a change (dU) in level of the U priority shown in Formula 12 satisfies a mean field Formula shown in the following Formula 13.

$$\frac{dU}{U} = \frac{dt}{T} - \frac{dx}{X} \qquad Formula 13$$

The calculation unit 104 may determine progress in processing of the lot by mean field approximation in relation to the length of stay of the lot in the stock B for the source. When the lot RT is put on standby in the stock B for a time Δt, the calculation unit 104 may, in accordance with Formula 13, update the level of the U priority (U) using the following Formula 14.

$$U \to U [ 1 + \frac{Δ t}{T} ] \qquad Formula 14$$

Whenever processing of the lot RT by the resource E is completed and the lot RT proceeds to the next resource E, the calculation unit 104 may determine progress in processing of the lot RT by mean field approximation. When the lot RT proceeds through one process, the calculation unit 104 may, in accordance with Formula 13, update the level of the U priority (U) using the following Formula 15.

$$U \to U [ 1 - \frac{1}{T} ] \qquad Formula 15$$

The calculation unit 104 feeds the level of the U priority for each lot RT that is to be processed by any one resource E to the processing unit 107.

The processing unit 107 implements the “Urgent Q-TIME Policy”, a priority determination algorithm that takes delivery urgency into consideration while meeting the Q-time constraint.

The processing unit 107 acquires the level of the Q priority for each Q lot RTq that is to be processed by any one resource E from the calculation unit 103. The processing unit 107 acquires the level of the U priority for each lot RT that is to be processed by any one resource E from the calculation unit 104.

The processing unit 107, based on Q priority information and U priority information, implements the “Urgent Q-TIME Policy”, a priority determination algorithm that takes delivery urgency into consideration while meeting the Q-time constraint.

The processing unit 107, based on the Q priority information, identifies the lot RT to which the Q priority is assigned out of the multiple lots RT that can be processed by the resource E with regard to each resource E. The processing unit 107 may identify the lot RT to which a largest level of the Q priority is assigned out of the multiple lots RT that can be processed by the resource E.

The processing unit 107, based on the U priority information, identifies the lot RT to which the U priority is assigned out of the multiple lots RT that can be processed by the resource E with regard to each resource E. The processing unit 107 may identify the lot RT to which a largest level of the U priority is assigned out of the multiple lots RT that can be processed by the resource E.

In response to a result of the identified lots, the processing unit 107 determines the lot RT that is to be preferentially processed by the resource E out of the multiple lots RT that can be processed by the resource E.

The processing unit 107 determines the lot RT to which the Q priority is assigned as a lot that is to be preferentially processed, if the level of the Q priority is greater than or equal to a threshold Qth; the length of lot stay is not well inside of the time constraint Tq; or a lot RT to which the level of the U priority exceeding a threshold Uth is assigned is not present. The threshold Qth may be experimentally determined in advance in relation to a value of the Q priority with which the lot RT is regarded as extremely urgent. The threshold Qth is 1, for example. The threshold Uth may be experimentally determined in advance in relation to a value of the U priority that is regarded as extremely urgent.

The processing unit 107 determines the lot to which the U priority is assigned as a lot that is to be preferentially processed, if the level of the Q priority is less than the threshold Qth; the length of lot stay is well inside of the time constraint Tq; and a lot to which the level of the U priority exceeding the threshold Uth is assigned is present.

The processing unit 107 puts a calculation result 2c, which includes the determined lot RT to be preferentially processed by the resource E, in the storage unit 2.

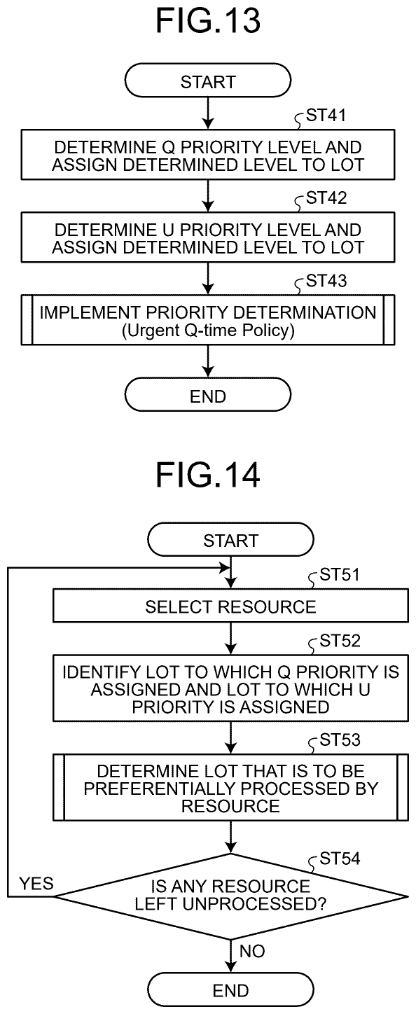

As illustrated in FIG. 13, an operation conducted by the management system 101 differs in the following respects from the operation in the first embodiment. FIG. 13 is a flowchart illustrating an outline of coordination between the Q priority and the U priority according to the second embodiment.

After ST1 to ST4 illustrated in FIG. 7 are performed, the management system 101 may perform ST41 to ST43 illustrated in FIG. 13.

The calculation unit 103 in the management system 101 determines a level of the Q priority and assigns the determined priority level to the lot RT (ST41).

The calculation unit 103 acquires the in-process information, the deadline information, and the Q-time constraint information from the storage unit 2. The calculation unit 103, based on the in-process information and the Q-time constraint information, determines a level of the Q priority for at least one lot RT out of the multiple lots RT that can be processed by the resource E with regard to each resource E in the manufacturing line P. The at least one lot RT includes a Q lot RTq. The calculation unit 103 may determine the level of the Q priority in association with the identifier of the manufacturing line P, the identifier of the resource E, and the identifier of the lot RT.

The calculation unit 103, based on the in-process information and the Q-time constraint information, identifies the lot RT on which the Q-time constraint is placed out of the multiple lots RT that can be processed by the resource E. The calculation unit 103, based on the deadline information and the Q-time constraint information, determines the level of the Q priority for the lot RT in response to a remaining time of the work period for the lot RT relative to the time constraint. The calculation unit 103 may determine the level of the Q priority (Qi) for each lot RT that is in process on the resource Ei using Formula 11.

The calculation unit 103 feeds the level of the Q priority for each lot RT that is to be processed by any one resource E to the processing unit 107.

The calculation unit 104 determines a level of the U priority and assigns the determined priority level to the lot RT (ST42).

The calculation unit 104 acquires the in-process information and the deadline information from the storage unit 2. The calculation unit 104, based on the in-process information and the deadline information, determines levels of the U priority for the multiple respective lots RT that are in process on the resource E with regard to each resource E for the manufacturing line P. The multiple lots RT include at least a U lot RTu and may further include a Q lot RTq. The calculation unit 104 may determine the levels of the U priority in association with the identifier of the manufacturing line P, the identifier of the resource E, and the identifiers of the respective lots RT.

The calculation unit 104 may determine the level of the U priority in response to a degree of progress relative to the deadline for delivery of the lot RT with regard to each of the multiple lots RT. The calculation unit 104 may determine the level of the U priority (U) using Formula 12.

In view of the fact that a total of the processes in the manufacturing line P is long and that mean field approximation is applicable to a local variation, the calculation unit 104 may determine progress in processing of the lot RT by mean field approximation.

The calculation unit 104 may determine progress in processing of the lot by mean field approximation in relation to the length of stay of the lot in the stock B for the source. When the lot RT is put on standby in the stock B for a time Δt, the calculation unit 103 may, in accordance with Formula 13, update the level of the U priority (U) using Formula 14.

Whenever processing of the lot RT by the resource E is completed and the lot RT proceeds to the next resource E, the calculation unit 104 may determine progress in processing of the lot RT by mean field approximation. When the lot RT proceeds through one process, the calculation unit 104 may, in accordance with Formula 13, update the level of the U priority (U) using Formula 15.

The calculation unit 104 feeds the level of the U priority for each lot RT that is to be processed by any one resource E to the processing unit 107.

The processing unit 107 implements the “Urgent Q-TIME Policy”, a priority determination algorithm that takes delivery urgency into consideration while meeting the Q-time constraint (ST43).

In ST43, ST51 to ST54 illustrated in FIG. 14, for example, may be performed. FIG. 14 is a flowchart illustrating priority determination according to the second embodiment.

The processing unit 107 acquires the level of the Q priority for each Q lot RTq that is to be processed by any one of the multiple resources E in the manufacturing line P from the calculation unit 103.

The processing unit 107 acquires the level of the U priority for each lot RT that is to be processed by any one of the multiple resources E in the manufacturing line P from the calculation unit 104.

The processing unit 107 selects a resource E subject to processing out of the multiple resources E (ST51).

The processing unit 107 identifies a lot to which the Q priority is assigned and a lot to which the U priority is assigned (ST52).

The processing unit 107, based on the Q priority information, identifies the lot RT to which the Q priority is assigned out of the multiple lots RT that can be processed by the resource E subject to processing.

The processing unit 107, based on the U priority information, identifies the lot RT to which the U priority is assigned out of the multiple lots RT that can be processed by the resource E subject to processing.

In response to a result of the identified lots, the processing unit 107 determines the lot RT that is to be preferentially processed by the resource E out of the multiple lots RT that can be processed by the resource E (ST53).

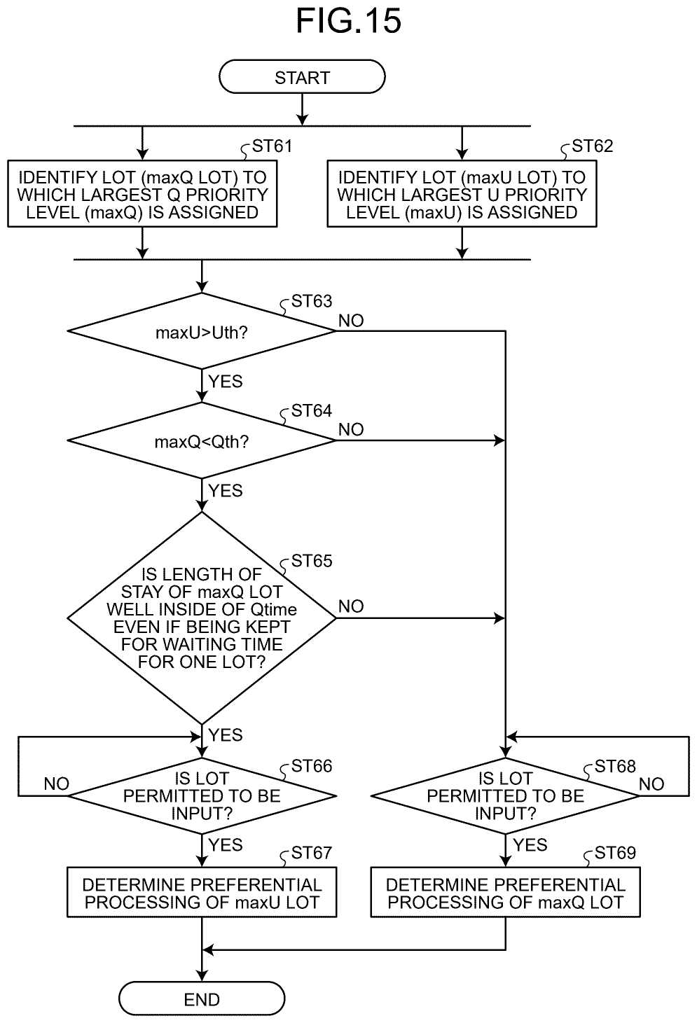

In ST53, ST61 to ST69 illustrated in FIG. 15 may be performed. FIG. 15 is a flowchart illustrating a process for determining the lot RT that is to be preferentially processed by the resource E according to the second embodiment. ST61 and ST62 may be performed concurrently.

In ST61, the processing unit 107 identifies the lot RT to which the largest level of the Q priority is assigned out of the multiple lots RT that can be processed by the resource E subject to processing. The lot RT to which the largest level of the Q priority is assigned is referred to as a maxQ lot.

In ST62, the processing unit 107 identifies the lot RT to which the largest level of the U priority is assigned out of the multiple lots RT that can be processed by the resource E subject to processing. The lot RT to which the largest level of the U priority is assigned is referred to as a maxU lot.

When both ST61 and ST62 are completed, the processing unit 107 determines whether or not the value of the U priority for the maxU lot RT is greater than the threshold Uth (ST63). The threshold Uth may be experimentally determined in advance in relation to a value of the U priority with which the lot RT is regarded as extremely urgent.

If the value of the U priority for the maxU lot RT is greater than the threshold Uth (Yes in ST63), the processing unit 107 determines whether or not the value of the Q priority for the maxQ lot RT is less than the threshold Qth (ST64). The threshold Qth may be experimentally determined in advance in relation to a value of the Q priority with which the lot RT is regarded as extremely urgent. The threshold Qth is 1, for example.

If the value of the Q priority for the maxQ lot RT is less than the threshold Qth (Yes in ST64), the processing unit 107 determines whether or not the length of stay of the maxQ lot RT in the constrained section SCq, even if being kept for a waiting time for one lot, is well inside of the time constraint Tq of the Q-time constraint (ST65).

If an amount of time remaining after subtracting the length of stay of the lot kept for the one lot waiting time from the time constraint Tq is greater than or equal to a threshold Tth, the processing unit 107 may determine that the length of the lot stay is well inside of the time constraint Tq. If the amount of remaining time is less than the threshold Tth, the processing unit 107 may determine that the length of the lot stay is not well inside of the time constraint Tq. The threshold Tth may be experimentally determined in advance as an amount of time against which the length of lot stay is regarded as well inside of the time constraint Tq.

If the length of the lot stay is well inside of the time constraint Tq (Yes in ST65), the processing unit 107 determines whether or not a lot is permitted to be input to the resource E subject to processing (ST66).

The processing unit 107 waits if the lot is not permitted to be input to the resource E subject to processing (No in ST66), and when the lot is permitted to be input to the resource E subject to processing (Yes in ST66), determines that the lot RT to be preferentially processed is the maxU lot RT (ST67) and inputs the maxU lot RT to the resource E.

Meanwhile, if the value of the U priority for the maxU lot RT is less than or equal to the threshold Uth (No in ST63); the value of the Q priority for the maxQ lot RT is greater than or equal to the threshold Qth (No in ST64); or the length of the lot stay is not well inside of the time constraint Tq (No in ST65), the processing unit 107 determines whether or not a lot is permitted to be input to the resource E subject to processing (ST68).

The processing unit 107 waits if the lot is not permitted to be input to the resource E subject to processing (No in ST68), and when the lot is permitted to be input to the resource E subject to processing (Yes in ST68), determines that the lot RT to be preferentially processed is the maxQ lot RT (ST69) and inputs the maxQ lot RT to the resource E.

When the process for determining the lot RT that is to be preferentially processed by the resource E is completed (ST53), the processing unit 107, if there is any resource E that is left unprocessed out of the multiple resources E in the manufacturing line P (Yes in S54), returns the processing to S51, selects the resource E subject to processing out of the resources E left unprocessed (S51), and performs S52 and S53 again.

If there is not any resource E that is left unprocessed out of the multiple resources E in the manufacturing line P (No in S54), the processing unit 107 ends the processing.

As described above, in the second embodiment, by the method of managing the manufacturing line P, the management system implements the “Urgent Q-TIME Policy”, a priority determination algorithm that takes delivery urgency into consideration while meeting the Q-time constraint. For example, if the level of the Q priority for a lot out of the multiple lots RT that can be processed by the resource E is less than the threshold Qth; the length of the lot stay is well inside of the time constraint Tq of the Q-time constraint; and the lot RT to which the level of the U priority exceeding the threshold Uth is assigned is present, the processing unit determines the lot RT to which the U priority is assigned as a lot RT that is to be preferentially processed. This makes it possible to appropriately coordinate the Q priority and the U priority, appropriately determine and process the level of the priority for each lot RT, and thus efficiently process the lots.

### Third Embodiment

A method of managing a manufacturing line according to a third embodiment will now be described. Differences from the first and the second embodiments will be primarily described below.

In the first embodiment, the process for identifying the resource E that is to be improved is exemplified, and in the second embodiment, the process for appropriately coordinating multiple priorities is exemplified. In the third embodiment, a process for identifying an amount of waiting time of a lot on a batch-fed resource will be exemplified.

In a manufacturing line P, multiple resources E include a resource E of a sheet-fed type that processes one lot by one lot and a resource E of a batch-fed type that processes a charge number of lots RT by batch when the number of lots in a stock B reaches the charge number.

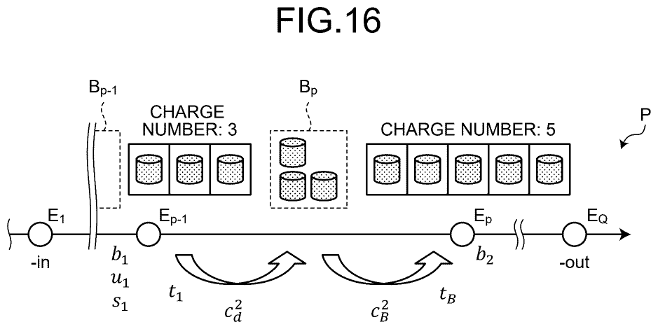

In the manufacturing line P as illustrated in FIG. 16, resources E of the batch-fed type having different charge numbers can be arranged in a series. FIG. 16 is a diagram illustrating resources of a batch-fed type according to the third embodiment. Of multiple batch-fed type resources Ep−1 and Ep arranged in a series, the resource Ep−1 is referred to as a front resource Ep−1, and the resource Ep is referred to as a subsequent resource Ep.

In a case of FIG. 16, the batch-fed type resources Ep−1 and Ep having different charge numbers are arranged in a series. The charge number of the front resource Ep−1 is three, and the charge number of the subsequent resource Ep is five, for example.

Since the batch-fed type resources E having different charge numbers are arranged in a series in the manufacturing line P, a lot RT can stay lengthily on the subsequent resource E. Thus, it is desirable to correctly identify an amount of waiting time of the lot RT on the subsequent resource E and improve a flow of the lot RT.

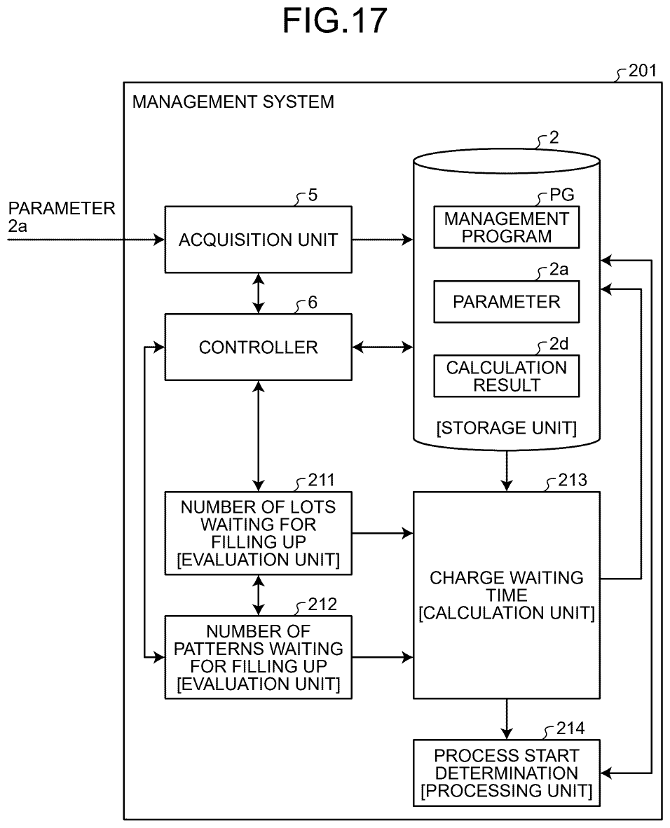

Each manufacturing line P as illustrated in FIG. 16 may be managed by a management system 201 illustrated in FIG. 17. FIG. 17 is a diagram illustrating a functional configuration of the management system 201.

The management system 201, in consideration of the charge numbers of the multiple batch-fed type resources Ep−1 and Ep arranged in a series in the manufacturing line P, determines an amount of waiting time of a lot RT input to the subsequent resource Ep.

At this time, the management system 201 may determine the amount of waiting time of the lot RT input to the subsequent resource Ep by applying Little's Law. Little's Law can be represented by the following Formula 16.

$$L = λ W \qquad Formula 16$$

In Formula 16, L indicates an average number of lots in a state of waiting in the stock B for the resource E. λ indicates an average arrival rate of lots RT arriving at the stock B for the resource E. W is an average waiting time a lot RT spends in the stock B.

The management system 201 includes an evaluation unit 211, an evaluation unit 212, a calculation unit 213, and a processing unit 214 rather than the calculation unit 3, the calculation unit 4, and the processing unit 7 (refer to FIG. 4).

Under control of the controller 6, the acquisition unit 5 acquires a parameter 2a. The parameter 2a further includes information about the lots RT that are in process on the resources E in the manufacturing line P, attributes of the resources E in the manufacturing line P, and the Q-time constraint.

Under control of the controller 6, the storage unit 2 may receive the parameter 2a from the acquisition unit 5 and store the parameter as a database. The database further includes in-process information, attribute information, and Q-attribute constraint information. The in-process information is information in which an identifier of the lot in process, an identifier of the manufacturing line P, and an identifier of the resource E are related to each other with regard to the multiple resources E. The attribute information is information in which a location of the resource, a class, a charge number, and an average processing time of the resource, the identifier of the manufacturing line P, and the identifier of the resource E are related to each other with regard to the multiple resources E. The resource class includes the sheet-fed type and the batch-fed type. The charge number is one for sheet-fed type resources and two or more for batch-fed type resources. The Q-time constraint information is information in which the time constraint, the identifier of the manufacturing line P, and the identifiers of the resources E associated with the constrained section SCq are related to each other.

The evaluation unit 211 acquires the in-process information and the attribute information from the storage unit 2 through the controller 6. The evaluation unit 211, based on information about the resource location included in the attribute information, identifies the multiple batch-fed type resources Ep−1 and Ep arranged in a series in the manufacturing line P.

The evaluation unit 211, based on information about the charge number included in the attribute information, identifies the charge numbers of the multiple batch-fed type resources Ep−1 and Ep.

Using the charge numbers of the multiple batch-fed type resources Ep−1 and Ep, the evaluation unit 211 determines a number of lots aₖ waiting for filling up on the subsequent resource Ep. The evaluation unit 211 may determine the number of lots aₖ waiting for filling up on the subsequent resource Ep using the following Formula 17.

$${a}_{k} = ( {a}_{k - 1} + {b}_{p - 1} ) mod {b}_{p} \qquad Formula 17$$

In Formula 17, bp−1 indicates the charge number of the front resource Ep−1. bp indicates the charge number of the subsequent resource Ep. aₖ₋₁ indicates a number of lots remaining on the subsequent resource Ep without reaching the charge number for a batch when a set of lots RT from the front resource Ep−1 arrives k−1 time(s). k is any integer from 2 to n+1 inclusive. aₖ indicates the number of lots remaining on the subsequent resource Ep without reaching the charge number for a batch when a set of lots RT from the front resource Ep−1 arrives k times. aₖ is equivalent to the quantity of stock on the subsequent resource Ep waiting for next one-time batch processing.

It should be noted that in Formula 17, a₀=aₙ=0.

Formula 17 shows that the number of lots aₖ waiting for filling up on arrival of a set of lots RT k times can be determined by taking a remainder after dividing the sum of the number of lots aₖ₋₁ waiting for filling up on arrival of a set of lots RT k−1 time(s) and the charge number of the front resource Ep−1 by the charge number of the subsequent resource Ep.

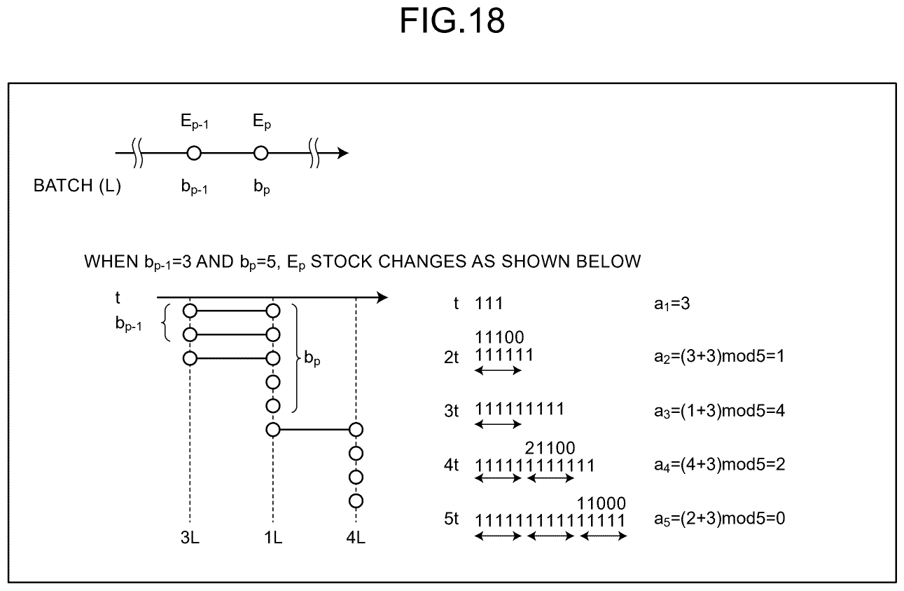

For example, when bp-1=3 and bp=5 as illustrated in FIG. 18, at k=1 (i.e., time t), the number of lots ai waiting for filling up=3. FIG. 18 is a diagram illustrating an example of the number of lots being input to a resource Ep of the batch-fed type according to the third embodiment. At k=2 (i.e., time 2t), the number of lots a waiting for filling up=(3+3) mod 5=1. At k=3 (i.e., time 3t), the number of lots a₃ waiting for filling up=(1+3) mod 5=4. At k=4 (i.e., time 4t), the number of lots a₄ waiting for filling up=(4+3) mod 5=2. At k=5 (i.e., time 5t), the number of lots a₅ waiting for filling up=(2+3) mod 5=0.

The evaluation unit 211 feeds the number of lots aₖ waiting for filling up on the subsequent resource Ep to the calculation unit 213.

The evaluation unit 212 acquires the attribute information from the storage unit 2 through the controller 6. The evaluation unit 212, based on information about the charge number included in the attribute information, identifies the charge numbers of the multiple batch-fed type resources Ep−1 and Ep.

Using the charge numbers of the multiple batch-fed type resources Ep−1 and Ep, the evaluation unit 212 determines a number of patterns n waiting for filling up on the subsequent resource Ep. The evaluation unit 212 may determine the number of patterns n waiting for filling up on the subsequent resource Ep using the following Formula 18.

$$n = \frac{l}{{b}_{p - 1}} \qquad Formula 18$$

In Formula 18, bp−1 indicates the charge number of the front resource Ep−1. bp indicates the charge number of the subsequent resource Ep. l indicates a least common multiple of the charge number bp−1 of the front resource Ep−1 and the charge number bp of the subsequent resource Ep.

Formula 18 shows that the number of patterns n waiting for filling up on the subsequent resource Ep can be determined by dividing the least common multiple of the charge number bp−1 of the front resource Ep−1 and the charge number bp of the subsequent resource Ep by the charge number bp−1 of the front resource Ep−1.

For example, when bp-1=3 and bp=5 as illustrated in FIG. 18, the number of patterns waiting for filling up is n=15/3=5. FIG. 18 illustrates five patterns waiting for filling up.

The evaluation unit 212 feeds the number of patterns n waiting for filling up on the subsequent resource Ep to the calculation unit 213.

The calculation unit 213 receives the number of lots aₖ waiting for filling up on the subsequent resource Ep from the evaluation unit 211 and receives the number of patterns n waiting for filling up on the subsequent resource Ep from the evaluation unit 212.

The calculation unit 213 determines an average number of lots L in a state of waiting in the stock Bp for the resource Ep by dividing the number of lots aₖ waiting for filling up on the subsequent resource Ep by the number of patterns n that a group of lots RT on the subsequent resource Ep can form when k pieces of lots from the front resource Ep−1 arrive at the subsequent resource Ep. The calculation unit 213 may determine the average number of lots L in a state of waiting in the stock Bp for the resource Ep using the following Formula 19.

$$L = \frac{{\sum }_{k = 1}^{n} {a}_{k}}{n} \qquad Formula 19$$

In Formula 19, Σaₖ indicates a value calculated by adding up the number of lots aₖ waiting for filling up on the subsequent resource Ep for k counting from 1 to n. n indicates the number of patterns n waiting for filling up on the subsequent resource Ep.

Formula 19 shows that the average number of lots L in a state of waiting in the stock Bp for the resource Ep can be determined by dividing Σaₖ, a value calculated by adding up the number of lots aₖ waiting for filling up on the subsequent resource Ep for k counting from 1 to n, by the number of patterns n waiting for filling up on the subsequent resource Ep.

The calculation unit 213 acquires operating rate information, operational availability information, and the attribute information from the storage unit 2 through the controller 6.

The calculation unit 213 extracts, from the operating rate information, an operating rate rp−1 corresponding to the identifier of the resource E of interest. The calculation unit 213 extracts, from the operational availability information, operational availability mp−1 corresponding to the identifier of the resource E of interest. The calculation unit 213 may divide the operating rate rp−1 by the operational availability mp−1 to determine a load factor up−1 of the front resource Ep−1.

The calculation unit 213 extracts, from the attribute information, an average processing time t_{Mp-1} corresponding to the identifier of the resource Ep−1 of interest.

The calculation unit 213, in response to information about the resource E location included in the attribute information, identifies a number of apparatuses sp−1 present in a process area Sp−1 that is shared with the resource Ep−1 of interest.

Using the load factor up−1 of the front resource Ep−1, the charge number bp−1 of the front resource Ep−1, the number of apparatuses sp−1 present in the process area Sp−1 shared with the front resource Ep−1, and the average processing time t_{Mp-1} of the front resource Ep−1, the calculation unit 213 may determine the average arrival rate λ of lots RT arriving at the stock Bp for the resource Ep. The calculation unit 213 may determine the average arrival rate A of lots RT arriving at the stock Bp for the resource Ep using the following Formula 20.

$$λ = \frac{{u}_{p - 1} {b}_{p - 1} {s}_{p - 1}}{{t}_{{M}_{p - 1}}} \qquad Formula 20$$

In Formula 20, up−1 indicates the load factor of the front resource Ep−1. bp−1 indicates the charge number of the front resource Ep−1. sp−1 indicates the number of apparatuses present in the process area Sp−1 shared with the resource Ep−1. t_{Mp-1} indicates the average processing time of the resource Ep−1.

Formula 20 shows that the average arrival rate A of lots RT arriving at the stock Bp for the resource Ep can be determined by multiplying the load factor up−1 of the resource Ep−1, the charge number bp−1 of the front resource Ep−1, and the number of apparatuses sp−1 present in the process area Sp−1 shared with the resource Ep−1 together and dividing the multiplication product by the average processing time t_{Mp-1} of the resource Ep−1.

The calculation unit 213 can determine, based on Formulas 16, 19, and 20, a charge waiting time per lot t_{batch} of the stock Bp for the resource Ep using the following Formula 21. The charge waiting time t_{batch} is equivalent to W=L/λ in Formula 16.

$${t}_{batch} = \frac{{\sum }_{k = 1}^{n} {a}_{k}}{n \cdot {u}_{p - 1} {b}_{p - 1} {s}_{p - 1}} {t}_{{M}_{p - 1}} \qquad Formula 21$$

The calculation unit 213 feeds the charge waiting time per lot t_{batch} of the stock Bp for the resource Ep to the processing unit 214.

The processing unit 214 receives the charge waiting time per lot t_{batch} of the stock Bp for the resource Ep from the calculation unit 213. The processing unit 214 acquires the Q-time constraint information from the storage unit 2. The processing unit 214, based on the Q-time constraint information, determines whether or not the resource Ep belongs to the constrained section SCq. If the source Ep belongs to the constrained section SCq, the processing unit, based on the Q-time constraint information, identifies the time constraint Tq for the constrained section SCq. The processing unit 214 may determine whether or not the charge waiting time t_{batch} is well inside of the time constraint Tq. If the charge waiting time t_{batch} is not well inside of the time constraint Tq, the processing unit 214 may determine that processing of the lots RT by the resource Ep of the batch-fed type be started.

The processing unit 214 acquires the in-process information from the storage unit 2. The processing unit 214, based on the in-process information, identifies the quantity of stock on the resource E subsequent to the resource Ep. In response to the charge waiting time t_{batch} and the quantity of stock on the resource E subsequent to the resource Ep, the processing unit 214 may determine whether or not a loss is to occur in operation of the resource E subsequent to the resource Ep. If a loss is to occur in operation of the resource E subsequent to the resource Ep, the processing unit 214 may determine that processing of the lots RT by the resource Ep of the batch-fed type be started.

The processing unit 214 puts a calculation result 2d, which includes a result of the above determination, in the storage unit 2.

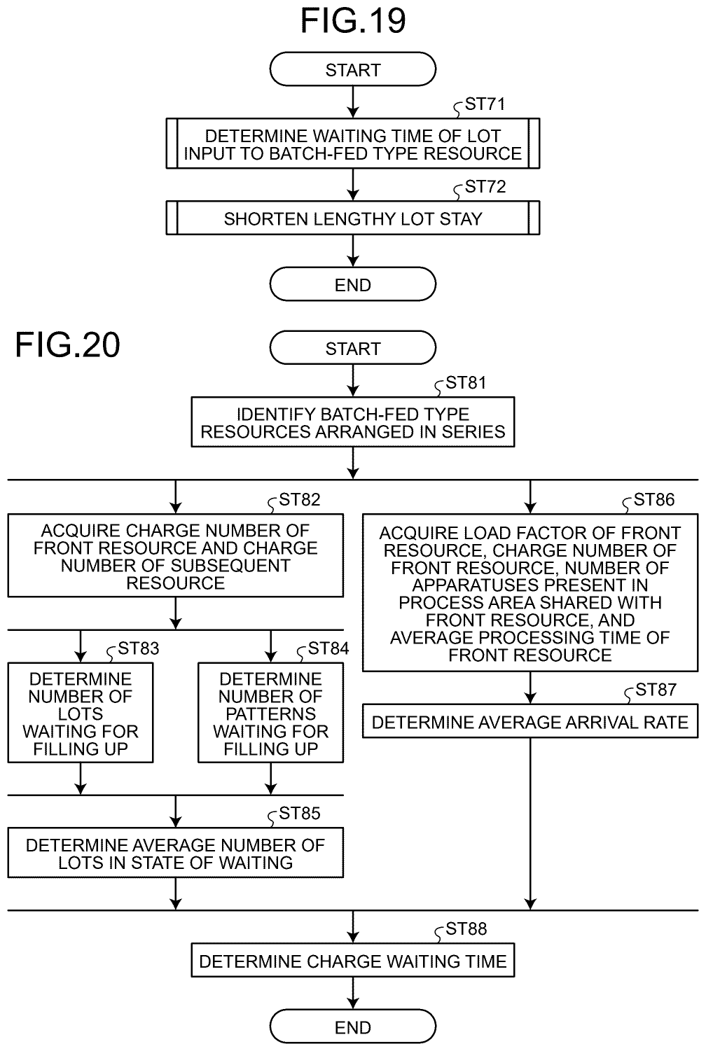

As illustrated in FIG. 19, an operation conducted by the management system 201 differs in the following respects from the operation in the first embodiment. FIG. 19 is a flowchart illustrating a process relating to a resource of the batch-fed type according to the third embodiment. FIG. 19 is a flowchart illustrating a process relating to a resource of the batch-fed type according to the third embodiment.

After ST1 to ST4 illustrated in FIG. 7 are performed, the management system 201 may perform ST71 to ST72 illustrated in FIG. 19.

The management system 201 determines the amount of waiting time of the lot RT input to the resource Ep of the batch-fed type (ST71).

In ST71, a process in ST81 to ST88 illustrated in FIG. 20 may be performed.

The evaluation units 211 and 212 each identify batch-fed type resources arranged in a series (ST81).

The evaluation units 211 and 212 each acquire the in-process information and the attribute information from the storage unit 2 through the controller 6. Based on information about the resource location included in the attribute information, the evaluation units 211 and 212 each identify the multiple batch-fed type resources Ep−1 and Ep arranged in a series in the manufacturing line P. The multiple batch-fed type resources Ep−1 and Ep include the front resource Ep−1 of the batch-fed type and the subsequent resource Ep of the batch-fed type.

After that, ST82 to ST85 and ST86 to ST87 may be performed concurrently.

In ST82 to ST85, the management system determines the average number of lots L in a state of waiting in the stock Bp for the resource Ep.

In ST82, the evaluation unit 211 acquires the charge number of the front resource Ep−1 of the batch-fed type.

The evaluation unit 211 extracts, from the attribute information, the charge number corresponding to the identifier of the front resource Ep−1 of the batch-fed type. As a result, the evaluation unit 211 acquires the charge number bp−1 of the front resource Ep−1 of the batch-fed type.

The evaluation unit 211 acquires the charge number of the subsequent resource Ep of the batch-fed type.

The evaluation unit 211 extracts, from the attribute information, the charge number corresponding to the identifier of the subsequent resource Ep of the batch-fed type. As a result, the evaluation unit 211 acquires the charge number bp of the subsequent resource Ep of the batch-fed type.

When ST82 is completed, ST83 and ST84 are performed concurrently.

In ST83, the evaluation unit 211 determines the number of lots aₖ waiting for filling up on the subsequent resource Ep. Using the charge number bp−1 of the front resource Ep−1 of the batch-fed type and the charge number bp of the subsequent resource Ep of the batch-fed type, the evaluation unit 211 determines the number of lots aₖ waiting for filling up on the subsequent resource Ep. The evaluation unit 211 may determine the number of lots aₖ waiting for filling up on the subsequent resource Ep using Formula 17.

The evaluation unit 211 feeds the number of lots aₖ waiting for filling up on the subsequent resource Ep to the calculation unit 213.

In ST84, the evaluation unit 212 determines the number of patterns n waiting for filling up on the subsequent resource Ep. Using the charge number bp−1 of the front resource Ep−1 of the batch-fed type and the charge number bp of the subsequent resource Ep of the batch-fed type, the evaluation unit 212 determines the number of patterns n waiting for filling up on the subsequent resource Ep. The evaluation unit 212 may determine the number of patterns n waiting for filling up on the subsequent resource Ep using Formula 18.

The evaluation unit 212 feeds the number of patterns n waiting for filling up on the subsequent resource Ep to the calculation unit 213.

When both ST83 and ST84 are completed, the calculation unit 213 determines the average number of lots L in a state of waiting in the stock Bp for the subsequent resource Ep.

The calculation unit 213 receives the number of lots aₖ waiting for filling up on the subsequent resource Ep from the evaluation unit 211 and receives the number of patterns n waiting for filling up on the subsequent resource Ep from the evaluation unit 212.

The calculation unit 213 determines the average number of lots L in a state of waiting in the stock Bp for the resource Ep by dividing the number of lots aₖ waiting for filling up on the subsequent resource Ep by the number of patterns n that a group of lots RT on the subsequent resource Ep can form when k pieces of lots from the front resource Ep−1 arrive at the subsequent resource Ep. The calculation unit 213 may determine the average number of lots L in a state of waiting in the stock Bp for the resource Ep using Formula 19.

In ST86 to ST87, the management system determines the average arrival rate A of lots RT arriving at the stock Bp for the subsequent resource Ep.

In ST86, the calculation unit 213 acquires the load factor of the front resource, the charge number of the front resource, the number of apparatuses present in the process area shared with the front resource, and the average processing time of the front resource.

The calculation unit 213 acquires operating rate information, operational availability information, and the attribute information from the storage unit 2 through the controller 6.

The calculation unit 213 extracts, from the operating rate information, the operating rate rp−1 corresponding to the identifier of the resource Ep−1 of interest. The calculation unit 213 extracts, from the operational availability information, the operational availability mp−1 corresponding to the identifier of the resource Ep−1 of interest. The calculation unit 213 may divide the operating rate rp−1 by the operational availability mp−1 to determine the load factor up−1 of the front resource Ep−1.

The calculation unit 213 extracts, from the attribute information, the average processing time t_{Mp-1} corresponding to the identifier of the resource Ep−1 of interest.

The calculation unit 213, in response to information about the resource E location included in the attribute information, identifies the number of apparatuses sp−1 present in the process area Sp−1 that is shared with the resource Ep−1 of interest.

In ST87, using the load factor up−1 of the front resource Ep−1, the charge number bp−1 of the front resource Ep−1, the number of apparatuses sp−1 present in the process area Sp−1 shared with the front resource Ep−1, and the average processing time t_{Mp-1} of the front resource Ep−1, the calculation unit 213 may determine the average arrival rate A of lots RT arriving at the stock Bp for the resource Ep. The calculation unit 213 may determine the average arrival rate λ of lots RT arriving at the stock Bp for the resource Ep using Formula 20.

When both ST82 to ST85 and ST86 to ST87 are completed, the management system determines the charge waiting time t_{batch} (ST88).

The calculation unit 213 determines the charge waiting time per lot t_{batch} by dividing the average number of lots L in a state of waiting in the stock Bp for the resource Ep by the average arrival rate λ of lots RT arriving at the stock Bp for the resource Ep. The calculation unit 213 can determine, based on Formulas 16, 19, and 20, the charge waiting time per lot t_{batch} of the stock Bp for the resource Ep using Formula 21.

The calculation unit 213 feeds the charge waiting time per lot t_{batch} of the stock Bp for the resource Ep to the processing unit 214.

When the process for determining the lot RT waiting time (ST71) is completed, the management system performs a process for shortening a lengthy lot RT stay (ST72).

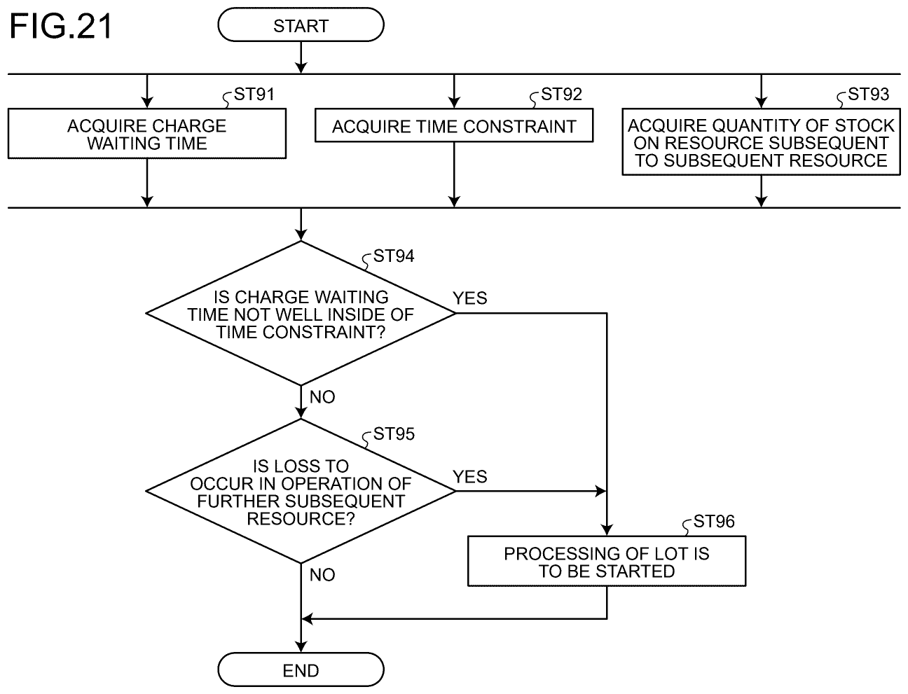

In ST72, ST91 to ST96 illustrated in FIG. 21 are performed. FIG. 21 is a flowchart illustrating a process for shortening a lengthy lot RT stay according to the third embodiment. ST91, ST92, and ST93 may be performed concurrently.

In ST91, the charge waiting time t_{batch} is acquired.

The processing unit 214 receives the charge waiting time per lot t_{batch} of the stock Bp for the resource Ep from the calculation unit 213.

In ST92, the time constraint Tq is acquired.

The processing unit 214 acquires the Q-time constraint information from the storage unit 2. The processing unit 214, based on the Q-time constraint information, determines whether or not the resource Ep belongs to the constrained section SCq. If the source Ep belongs to the constrained section SCq, the processing unit 214, based on the Q-time constraint information, identifies the time constraint Tq for the constrained section SCq.

In ST93, the quantity of stock on the resource E located subsequent to the subsequent resource Ep is acquired.

The processing unit 214 acquires the in-process information and the attribute information from the storage unit 2. The processing unit 214, based on the in-process information, identifies the quantity of stock on the resource E subsequent to the resource Ep.

When all ST91, ST92, and ST93 are completed, the processing unit 214 determines whether or not the charge waiting time t_{batch} is well inside of the time constraint Tq (ST94).

The processing unit 214 subtracts the charge waiting time t_{batch} from the time constraint Tq to determine a time difference and compares the time difference with a threshold Tth. The processing unit 214 may determine that the charge waiting time t_{batch} is well inside of the time constraint Tq if the time difference is greater than or equal to the threshold Tth, and may determine that the charge waiting time t_{batch} is not well inside of the time constraint Tq if the time difference is less than the threshold Tth.

The threshold Tth may be experimentally determined in advance as an amount of time against which the length of lot stay is regarded as well inside of the time constraint Tq. The threshold Tth may be identical to or different from the threshold Tth used in the second embodiment.

If the charge waiting time t_{batch} is not well inside of the time constraint Tq (Yes in ST94), the processing unit 214 determines that processing of the lots RT by the subsequent resource Ep of the batch-fed type be started without waiting to reach the charge number for a batch (ST96).

If the charge waiting time t_{batch} is well inside of the time constraint Tq (No in ST94), the processing unit 214 determines whether or not a loss is to occur in operation of the resource E subsequent to the subsequent resource Ep (ST95).

The processing unit 214 acquires, from the attribute information, an average processing time corresponding to an identifier of the further subsequent resource E. The processing unit 214, in response to the quantity of stock on the further subsequent resource E and the average processing time of the further subsequent resource E, determines an expected time in which the stock is expected to run out. The processing unit 214 compares the charge waiting time t_{batch} with the expected time. The processing unit 214 determines that a loss is to occur in operation of the further subsequent resource E if the charge waiting time t_{batch} is longer than the expected time, and determines that a loss is not to occur in operation of the further subsequent resource E if the charge waiting time t_{batch} is less than or equal to the expected time.

If a loss is to occur in operation of the further subsequent resource E (Yes in ST95), the processing unit 214 determines that processing of the lots RT by the subsequent resource Ep of the batch-fed type be started without waiting to reach the charge number for a batch (ST96).

If a loss is not to occur in operation of the further subsequent resource E (No in ST95), the processing unit 214 puts the calculation result 2d, which includes a result of the above determination, in the storage unit 2 and ends the processing.

As described above, in the third embodiment, by the method of managing the manufacturing line P, the management system determines the charge waiting time t_{batch} of the subsequent resource Ep of the multiple batch-fed type resources Ep−1 and Ep arranged in a series, and determines whether the lot RT stays lengthily using the charge waiting time t_{batch}. If the lot RT may stay lengthily, the management system determines that the lot RT be performed by the subsequent resource Ep of the batch-fed type without waiting to reach the charge number for a batch. This can reduce occurrence of a lengthy lot RT stay in the manufacturing line P since the subsequent resource Ep of the batch-fed type starts processing of the lot RT in response to the determination result. In other words, this makes it possible to efficiently process lots on the manufacturing line P.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A method of managing a manufacturing line, the method comprising:
determining a variation characteristic of a load factor of the manufacturing line that includes multiple resources;
determining a variation characteristic of a load factor of each of the multiple resources; and
identifying the resource that is to be improved out of the multiple resources in response to the variation characteristic of the load factor of the manufacturing line and the variation characteristic of the load factor of the resource.

2. The method according to claim 1, wherein
identifying the resource that is to be improved comprises:
determining a variation characteristic of a difference between the load factor of the resource and the load factor of the manufacturing line with regard to each of the multiple resources;
applying statistical processing to the variation characteristic of the difference with regard to each of the multiple resources; and
identifying, in response to a result of the statistical processing, the resource that constitutes a bottleneck out of the multiple resources, the resource that constitutes the bottleneck being the resource for which a lot stays lengthily.

3. The method according to claim 2, wherein
determining the variation characteristic of the difference comprises subtracting the load factor of the manufacturing line from the load factor of the resource to determine the difference for each of multiple periods with regard to each of the multiple resources, and
applying the statistical processing comprises adding up each of the differences for the multiple periods with regard to each of the multiple resources.

4. The method according to claim 3, wherein
identifying the resource that constitutes the bottleneck comprises designating the resource that has a largest amount of the added up differences as the resource that constitutes the bottleneck out of the multiple resources.

5. The method according to claim 1, wherein
determining the variation characteristic of the load factor of the manufacturing line comprises determining the load factor of the manufacturing line in view of a non-homogeneous Poisson process, and
determining the variation characteristic of the load factor of each of the multiple resources comprises determining the load factor of each of the multiple resources in view of the non-homogeneous Poisson process.

6. The method according to claim 5, wherein
determining the variation characteristic of the load factor of the manufacturing line comprises determining the load factor of the manufacturing line corresponding to a number of lots input to the manufacturing line and a number of lots output from the manufacturing line for each of multiple periods, and
determining the variation characteristic of the load factor of each of the multiple resources comprises determining the load factor of the resource corresponding to an operating rate of the resource and operational availability of the resource for each of the multiple periods.

7. The method according to claim 1, further comprising:
identifying a lot to which a level of a first priority relating to quality is assigned and a lot to which a level of a second priority relating to a deadline for delivery is assigned out of multiple lots that can be processed by the resource; and
determining, in response to a result of the identified lots, the lot that is to be preferentially processed by the resource out of the multiple lots.

8. The method according to claim 7, wherein
identifying the lot to which the first priority is assigned and the lot to which the second priority is assigned comprises:
identifying the lot to which the largest level of the first priority is assigned out of the multiple lots; and
identifying the lot to which the largest level of the second priority is assigned out of the multiple lots.

9. The method of according to claim 7, wherein
determining the lot comprises determining the lot to which the first priority is assigned as the lot that is to be preferentially processed on condition that the level of the first priority is greater than or equal to a first threshold, a length of stay of the lot is not well inside of a time constraint, or the lot to which the level of the second priority exceeding a second threshold is assigned is not present.

10. The method according to claim 9, wherein
determining the lot comprises determining the lot to which the second priority is assigned as the lot that is to be preferentially processed on condition that the level of the first priority is less than the first threshold, the length of stay of the lot is well inside of the time constraint, and the lot to which the level of the second priority exceeding the second threshold is assigned is present.

11. The method according to claim 7, wherein
the level of the first priority is set in response to a remaining time of a work period for the lot relative to a time constraint, and
the level of the second priority is set in response to a degree of progress on the lot relative to the deadline for delivery.

12. The method according to claim 11, wherein
the level of the second priority is determined by applying mean field approximation to progress in processing the lot.

13. The method according to claim 12, wherein
the level of the second priority is determined by applying the mean field approximation to progress in processing the lot in relation to an elapsed time for which the lot is in a stock for the resource.

14. The method according to claim 12, wherein
the level of the second priority is determined by applying the mean field approximation to progress in processing the lot whenever processing of the lot by the resource is completed and the lot proceeds to the next resource.

15. The method according to claim 1, further comprising determining an amount of waiting time of a lot input to a first resource of a batch-fed type by applying Little's Law in consideration of a charge number of the first resource.

16. The method according to claim 15, wherein
determining the amount of waiting time comprises:
determining an average number of lots in a state of waiting by dividing a number of lots waiting for filling up on the first resource by a number of patterns that a group of lots on the first resource can form when k pieces of lots from a second resource of the batch-fed type arrive at the first resource, the second resource being configured to process lots before the first resource does;
determining an average arrival rate of lots arriving at the first resource; and
determining a charge waiting time per lot of a stock for the first resource by dividing the average number of lots in the state of waiting by the average arrival rate.

17. The method according to claim 16, wherein
the number of patterns is determined by dividing a least common multiple of a charge number of the second resource and the charge number of the first resource by the charge number of the second resource.

18. The method according to claim 15, further comprising determining that processing by the resource of the batch-fed type be started on condition that the determined amount of waiting time is not well inside of a time constraint.

19. A method of managing a manufacturing line, the method comprising:
identifying a lot to which a level of a first priority relating to quality is assigned and a lot to which a level of a second priority relating to a deadline for delivery is assigned out of multiple lots that can be processed by a resource in the manufacturing line including multiple resources; and
determining, in response to a result of the identified lots, the lot that is to be preferentially processed by the resource out of the multiple lots.

20. A method of managing a manufacturing line, the method comprising
determining waiting time of a lot input to a first resource of a batch-fed type in the manufacturing line including multiple resources by applying Little's Law in consideration of a charge number of the first resource.
